(19) United States
(12) Patent Application Publication
(10) Pub. No.: US 2025/0155626 A1
(43) Pub. Date: May 15, 2025

(54) Component for a Glare Suppression Device

(71) Applicant: Envisics Ltd, Milton Keynes (GB)

(72) Inventor: Yiren Xia, Milton Keynes (GB)

(21) Appl. No.: 18/926,114

(22) Filed: Oct. 24, 2024

(30) Foreign Application Priority Data
Nov. 10, 2023 (GB) 2317241.4

(51) Int. Cl. F21V 8/00; G02B 27/01

(52) U.S. Cl. CPC G02B 6/0016; G02B 6/0036; G02B 6/0065; G02B 27/0101

(57) ABSTRACT

There is provided a component for a light control device. The component comprises a first serrated structure. The first serrated structure has an array of active faces and a respective array of passive faces. Each passive face comprises a first layer having at least one structural feature configured to suppress the specular reflection of ambient light incident thereon.

### CROSS-REFERENCE TO RELATED APPLICATIONS

The present application claims priority under 35 U.S.C. § 119 to UK Patent Application GB 2317241.4 titled “Component for a Glare Suppression Device,” filed on Nov. 10, 2023, and currently pending. The entire contents of GB 2317241.4 are incorporated by reference herein for all purposes.

### FIELD

The present disclosure relates to a component for a light control layer (or for a reflection suppression or glare mitigation device). The present disclosure also relates to a light control layer comprising the component and to a head-up display comprising the light control layer. The present disclosure further relates to methods of manufacturing the component. Some embodiments relate to a holographic projector, picture generating unit or head-up display.

### INTRODUCTION

Light scattered from an object contains both amplitude and phase information. This amplitude and phase information can be captured on, for example, a photosensitive plate by well-known interference techniques to form a holographic recording, or “hologram”, comprising interference fringes. The hologram may be reconstructed by illumination with suitable light to form a two-dimensional or three-dimensional holographic reconstruction, or replay image, representative of the original object.

Computer-generated holography may numerically simulate the interference process. A computer-generated hologram may be calculated by a technique based on a mathematical transformation such as a Fresnel or Fourier transform. These types of holograms may be referred to as Fresnel/Fourier transform holograms or simply Fresnel/Fourier holograms. A Fourier hologram may be considered a Fourier domain/plane representation of the object or a frequency domain/plane representation of the object. A computer-generated hologram may also be calculated by coherent ray tracing or a point cloud technique, for example.

A computer-generated hologram may be encoded on a spatial light modulator arranged to modulate the amplitude and/or phase of incident light. Light modulation may be achieved using electrically-addressable liquid crystals, optically-addressable liquid crystals or micro-mirrors, for example.

A spatial light modulator typically comprises a plurality of individually-addressable pixels which may also be referred to as cells or elements. The light modulation scheme may be binary, multilevel or continuous. Alternatively, the device may be continuous (i.e. is not comprised of pixels) and light modulation may therefore be continuous across the device. The spatial light modulator may be reflective meaning that modulated light is output in reflection. The spatial light modulator may equally be transmissive meaning that modulated light is output in transmission.

A holographic projector may be provided using the system described herein. Such projectors have found application in head-up displays, “HUD”.

### SUMMARY

Aspects of the present disclosure are defined in the appended independent claims.

In a first aspect there is provided a component for a light control device. In some embodiments, the light control device is a glare mitigation device. In some embodiments, the light control device is a glare mitigation device for a head-up display for a vehicle. In some embodiments, the glare mitigation device is for suppressing glare from a reflective surface of an optical component, for example a reflective surface of an optical component of a head-up display for a vehicle. For example, the reflective surface may be a reflective surface of a waveguide pupil expander of a head-up display for a vehicle.

The component comprises a first serrated structure or first serrated surface. In some embodiments, it may be said that the first serrated structure comprises a first serrated surface. The first serrated structure comprises an array of active faces and a respective array of passive faces. In some embodiments, the active and passive faces of the first serrated structure are arranged in an alternating configuration. At least one, optionally some or each, passive face comprises a first layer. The first layer has at least one structural feature, optionally a plurality of structural features, configured to suppress the specular reflection of ambient light incident thereon. For example, the at least one structural feature may be sized or shaped to suppress specular reflection of light incident thereon.

Suppressing specular reflection may mean that the majority of light incident thereon is not specularly reflected. In some embodiments, less than 10% of light incident thereon is specularly reflected, optionally less than 5% or less than 1% of light incident thereon is specularly reflected. Suppressing specular reflection may mean that light incident thereon is diffusely reflected (or otherwise scattered) rather than being specularly reflected. Alternatively or additionally, suppressing specular reflection may mean that light incident thereon is absorbed rather than being specularly reflected.

As above, the component of the first aspect comprises a first serrated structure. The first serrated structure provides a light control or glare mitigation function. A light control layer comprising serrations/a serrated surface for suppressing glare has previously been disclosed in UK patent number GB2607672B. In GB2607672B, it was described how the serrations of a sunlight-receiving surface provides an array of angled surfaces that can be arranged to direct sunlight away from a particular area, for example away from the eye-box of a head-up display. In particular, each of the angled surfaces forms an interface between a material forming the serrated surface and air such that most of the sunlight incident thereon (e.g. 96% of incident sunlight) is reflected (i.e. not coupled into the light control device/component). The angled surfaces are orientated at an angle with respect to a plane of the light control device. The angled surfaces are arranged to direct the reflected sunlight away from a direction towards the eye-box, owing to the orientation angle thereof. It was also described in GB2607672B how, in examples, the angled surfaces of the sunlight-receiving surface change the angle of reflection of sunlight incident thereon. That is, the angle of rays of sunlight received by the angled surfaces is different from the angle of rays of the sunlight reflected by the angled surfaces, where the angles of the rays of sunlight are measured with respect to (the normal to) the plane of the light control film/optical component in the first and second dimensions. It may be said that each angled surface changes the course or path of specular reflection of incident sunlight in comparison to specular reflection by non-angled surfaces (parallel to a plane of the light control component).

After thorough experimentation and simulation, the inventors have found that the light control layer of GB2607672B is generally very effective at controlling light/mitigating glare. However, the inventors have found that there may be one or more specific cases in which specular reflections are not prevented from reaching a particular target (e.g. an eye-box of a head-up display). In more detail, ambient light may be incident on a light control device over a wide range of different angles during use (the angle being defined with respect to a normal of the sunlight-receiving surface). The inventors have found that, at some very specific angles of the ambient light within the range, the ambient light may be specularly reflected by a passive face of the serrated structure. The inventors have found that the specularly reflected light may unintentionally follow a light path towards the target (e.g. an eye-box of a head-up display) and so may form a source of glare. The inventors have also identified that there may be angles at which light may be transmitted through the passive faces of the serrated structure to reach the target/eye-box. The inventors have therefore recognised that there is a need to adapt the serrated structure to prevent transmission/specular reflections at said specific angles resulting in light/glare reaching the target/eye-box.

The inventors applied a (black) paint layer to the passive faces of the serrated structure. It was assumed that the (black) paint layer would absorb and/or diffusely scatter light incident on the passive faces (both light incident on the passive face internally and externally). After further thorough simulation and experimentation, the inventors have surprisingly found another source of glare from the serrated structure. The serrated structure may be formed of a transparent material—such as a bulk polymer that is transparent. The inventors have identified that the interface between the material forming the serrated structure (including the passive faces) and the (black) paint (or air, if the paint is not present) can cause internal specular reflections within the serrated structure because of a difference in refractive index of the material forming the serrated surface and the refractive index of the (black) paint (or air). Of course, this is only possible at a specific angular range (depending on the critical angle, which itself depends on the respective refractive indices of the materials at the interface). Furthermore, there is an even smaller angular range where the internal specular reflections actually results in glare/light being transmitted to a target/eye-box. However, the inventors have recognised that it may be important to eliminate the possibility of glare at all angles, even if glare may be relatively unlikely to occur because of having very narrow angular conditions in order for the glare to be formed.

The component of the first aspect eliminates/suppresses the identified source of glare by providing a first layer on each passive surface that has at least one structural feature, optionally a plurality of structural features, configured to suppress the specular reflection of ambient light incident thereon. The inventors have recognised that providing such a first layer which suppresses specular reflection by virtue of structural features is advantageous because there may be no angles at which internal specular reflections off the passive face are achievable. In some examples, the inventors have recognised that it may be advantageous for the first layer to be formed from a material having substantially the same refractive index as the material forming the passive face. This may prevent internal specular reflections at all angles because there is no significant interface of differing refractive indices. A paint layer may then be added to the first (specular reflection suppression) layer such that the first layer is between the passive face and the paint layer. The paint layer may absorb light which is transmitted through the passive face (which may already have been diffusely scattered by the first layer).

In some embodiments, the first serrated structure is formed of a transparent core material. The first transparent core material may have a first refractive index. Each respective first layer of each passive face may comprise a material having a refractive index that is substantially equal to the first refractive index. Herein, the refractive index of each first layer being substantially equal to the first refractive index may mean that the refractive index of each first layer is within +/−10% of the first refractive index, optionally within +/−5% of the first refractive index, optionally within +/−1% of the first refractive index. In some embodiments, the refractive index of each first layer may be equal to the first refractive index (for example, if the first layer comprises/consists of the same material as the transparent core material). As described above, the refractive indices of said materials being substantially equal (or exactly equal) advantageously means that an interface having a differential refractive index does not exist between the passive face and the first layer. Thus, specular reflections (in particular, internal specular reflections within an individual serration of the serrated structure) are prevented/suppressed.

In some embodiments, the first serrated structure comprises a plurality of serrations. Each serration may comprise an active face of the array of active faces and a respective passive face of the array of passive faces. As such, the active faces and passive faces may be arranged in an alternating configuration. Each active face may be described as forming a first facet surface of an individual serration. Each passive face may be described as forming a second facet face of an individual serration. The active face and passive face of each serration may meet at a respective corner. Each active face may make a first angle with respect to a plane of the component. Each passive face may make a second angle with respect to a plane of the component. The first angle may be different to the second angle.

Each serration may extend longitudinally in a first dimension. As such, each active face and each passive face may also extend longitudinally in the first dimension. The plurality of serrations may form an array extending in a second dimension that is perpendicular to the first dimension. The first and second dimensions may together define a first plane. The component may extend substantially in a plane that is substantially parallel to the first plane. Herein, unless otherwise specified, the angles and shape of the active and passive face may be defined in terms of a cross-section of the component in a second plane containing a normal of the component. In other words, the second plane may contain a third dimension that is perpendicular to the first and second dimensions. The second plane may also contain the second dimension. In other words, the second plane may cut through each of the plurality of serrations of the first serrated structure. The first angle may be an angle between a plane defined by the respective active face and the first plane. The second angle may be an angle between a plane defined by the respective passive face and the first plane.

As used herein, an active face of the first serrated structure may refer to a face through which it is intended for light to be transmitted. For example, if the component of the first aspect is used in a glare mitigation device for a head-up display, the active faces may be the faces of the serrated structure through which the light of the head-up display passes. The head-up display light is referred to as HUD-light herein. The HUD-light may be spatially modulated light and/or a holographic wavefront. As the skilled reader will appreciate, it may be important for the active faces to have a minimal impact on the HUD-light. For example, the active faces may be polished so as to allow for transmission of the HUD-light through the active face without surface roughness adversely affecting the HUD-light, for example by reducing image quality.

As used herein, a passive face of the first serrated structure may refer to a face through which it is not intended for light to be transmitted. For example, each passive face may comprise an additional or second layer, such as a paint layer, arranged to absorb light such that light may not be transmitted through the passive face. In other words, each passive face may be arranged to be substantially non-transmissive or opaque. The passive face may be angle so as to be parallel to HUD-light passing through the component when the component is in use. This may minimise the impact of the passive face on the HUD-light. In particular, this may minimise the amount of HUD-light that is absorbed by the passive face. Thus, each passive face may advantageously be arranged to not block the HUD-light (which may be intended to be received at an eye-box) while blocking light at other angles which may include sunlight/glare or otherwise scattered light.

As described above, the first serrated structure comprises a plurality of angled surfaces arranged to direct ambient light/glare away from a target such as an eye-box when the first component is used. It may be the active faces which form this plurality of angled surfaces. The skilled reader will appreciate that a single, much larger, angled surface could be provided to direct ambient light in this way. However, this might result in very bulky structure. In particular, as the structure increases in size in the second dimension, then this thickness of the serration would need to increase in the third dimension to achieve the same angled (single) active surface. The inventors have recognised that providing an array of serrations, rather than one large serration, means that the same angular deflection may be achieved while reducing the overall thickness in the third dimension. The effect is similar to that of Fresnel lens. Each individual serration provides an active surface. The plurality or array of active surfaces together combine to effectively perform as a single composite angled surface but with a significantly reduced thickness in the third dimension. As the skilled reader will appreciate, the existence of a plurality of serrations may require the passive face to exist between each active face. The passive faces may not exist if a single serration, large and thick, serration were provided. Otherwise, the serrations would form a discontinuous structure. The inventors have surprisingly found that the passive faces introduce a potential source of glare even when coated with an opaque coating such as black paint, as described above. The first layers on the passive faces, described above, suppresses this source of glare.

Each of the serrations may be formed by a portion of the serrated structure that is angled with respect to a general plane of the component. The or each portion of the serrated structure forming a serration may have a constant angle with respect to the plane of the reflection suppression device. In other words, the serration/angled surface may have a linear profile. In particular, each active face may have a linear profile. The serrated surface may be described as having a sawtooth configuration or shape. Alternatively, the or each portion of the serrated surface forming a serration may have a changing angle with respect to the plane of the reflection suppression device. In other words, the active surface may have a curved profile. In some embodiments, the serrations provide an array of angled surfaces that direct sunlight. In the context of a head-up display, the angled surfaces may direct sunlight-including sunlight reflected by another optical component of the system-away from the eye-box. In particular, each of the angled surfaces forms an interface between the core material and air such that most of the sunlight incident thereon (e.g. more than 95% of incident sunlight) is reflected.

In some embodiments the respective first layer of each passive face comprises a polymer. In some embodiments, the respective first layer of each passive face comprises a porous polymer. The (porous) polymer may be configured to suppress specular reflection of (ambient) light incident thereon. Alternatively or additionally, in some embodiments the structural feature is contained within a polymer.

In some embodiments, the structural feature(s) configured to suppress specular reflection are features of the structure of the polymer. For example, a porous polymer may comprise structural features such as pores, fibrils, or fibres. Said structural features may be configured to suppress specular reflection.

In some embodiments, the structural feature(s) configured to suppress specular reflection are features formed within the polymer. For example, a pattern may be imprinted in the passive faces of the first serrated structure. Said pattern may have a structure arranged to suppress specular reflection. The pattern may be in the form of surface roughness on the passive surface. For example, a pattern of indentations may be formed the passive surface. In some embodiments, the first serrated structure is manufactured using an injection moulding method. In such embodiments, the pattern may be formed as a result of a pattern formed on the inside of the mould used in the injection moulding process. In some embodiments, the pattern may be formed by hot embossing.

The structural feature(s) of the first layer of each passive surface being arranged or configured to suppress specular reflection of ambient light incident thereon may mean that the structural feature(s) have a size or shape that is such that light incident thereon is not specular reflected. Instead, the structural feature(s) of the first layer of each passive surface may be sized or shaped to scatter (e.g. diffusely reflect) ambient light incident thereon, and/or to absorb ambient light incident thereon. The inventors have found that a suitable size of the structural feature(s) to achieve said effect may depend on the wavelength of the incident light. In some embodiments, the at least one structural feature has a size of between 50 and 800 nanometres, optionally between 200 and 500 nanometres. The size may refer to a median or mean average size of the structural features when there are a plurality of structure features. The inventors have found that said ranges in size of the structural features may be particularly advantageous for suppressing specular reflections of visible ambient light.

In some embodiments, the respective first layer of one or more passive faces comprises at least one structural feature in the form of one or more pores. Such a layer may be referred to as a porous first layer. Such a first layer may comprise a porous polymer. In such embodiments, the structural feature size may refer to the diameter of individual pores of the porous structure.

In some embodiments, the respective layer of one or more passive faces comprises at least one structural feature in the form of one or more fibres or fibrils. Such a layer may also be referred to as a porous first layer because the fibres or fibrils may define pores or interstices therebetween. In such embodiments, the structure feature size may refer to a diameter of the individual fibres or fibrils and/or may refer to a width of interstices formed between adjacent fibres or fibrils.

In some embodiments, structural features of at least one first layer of the passive faces may form a fibril network, such as anisotropic fibril network. The inventors have found that such a fibril network (or anisotropic fibril network) may advantageously be diffusely reflective and/or scatter visible light incident thereon.

In some embodiments, the component comprises a bulk polymer forming the first serrated structure. In some embodiments, the bulk polymer comprises a substantially transparent material. In some embodiments, the bulk polymer comprises polymethyl methacrylate (PMMA).

In some embodiments, a refractive index of the bulk polymer is substantially the same as a refractive index of the first layer of each passive face. As described above, this may suppress internal specular reflections of ambient light propagating from the bulk polymer to the first layer (i.e. propagating through the bulk polymer/first layer interface). This may be because there may be no significant change in the refractive index of the materials forming said interface.

In some embodiments, the bulk polymer comprises a first polymer. The first layer of each passive face may be a polymer layer also comprising the first polymer. The first polymer may be polymethyl methacrylate (PMMA).

In some embodiments, the first layer of each passive face is a thin film polymer layer. For example, the first layer of each passive face may have a film thickness of less than 100 micrometres, optionally less than 50 micrometres, optionally less than 10 micrometres.

In some embodiments, each passive face further comprises a second layer configured to substantially absorb light incident thereon. The first layer may be sandwiched between the first serrated component and the second layer. As such, light propagating through the first serrated component may pass through the first layer and then the second layer. The second layer may comprise (or consist of) paint, optionally black paint. In some embodiments, the second layer partially permeates the first layer. For example, if the second layer comprises paint, the paint may permeate into the first layer. This may mean that the paint permeates into (or at least partially fills) at least some pores/interstices of the first layer. The inventors have found that this may improve the ability of the second layer to absorb light that has been scattered by structural features of the first layer.

As described above, the active face(s) of the first serrated component advantageously have a relatively low surface roughness. This may be so as to not adversely affect HUD-light passing therethrough. In some embodiments, a root mean square surface roughness of each active surface is 0.1 micrometers or less, optionally 0.05 micrometers or less. The inventors have found that these values of surface roughness are particularly preferred when the HUD-light is visible light. The inventors have found that such values for root mean square surface roughness may result in the active face effectively acting as an optically clear aperture for (visible) HUD-light. It may be necessary to polish the active surfaces to achieve said root mean square surface roughness.

The inventors have found that the root mean square surface roughness of the passive face/first layer may need to be relatively significantly higher than that of the active face. The surface roughness may be caused by the at least one structural feature(s) of the first layer of each passive layer, for example by pores, fibres, interstices, or patterns formed in or on the passive face. In some embodiments, the root mean square surface roughness of each first layer/of the passive face/first layer may be at least 5 times greater, optionally at least 10 times greater, than the root mean square surface roughness of the active face. In some embodiments, a root mean square surface roughness of each passive surface is 0.5 micrometers or greater, optionally 0.7 micrometers or greater.

In the present disclosure, the root mean square surface roughness of a material is a measure of the square root of the mean (average) of the squared deviations of the surface profile from its mean height. In other words, it represents the standard deviation of the surface height values from the mean height. The resulting value provides a quantitative measure of the surface's deviation from perfect smoothness. A higher value indicates a relatively rougher surface, while a lower value indicates a relatively smoother surface.

In a second aspect, there is provided a light control device, which may be referred to as a glare mitigation device. The light control device comprises the component of the first aspect. In some embodiments, the light control device further comprises a plurality of louvres in an array, each louvre comprising a light absorbing material.

In some embodiments, the light control device comprises a first layer comprising the component of the first aspect. The light control device may further comprise an intermediate layer comprising the array of louvres. The light control device may be arranged, in use, to receive HUD-light at the intermediate layer before the first layer. Thus, the light control device may be arranged such that HUD-light may be received at the first layer from the intermediate layer. In some embodiments, a periodicity of the first serrated surface is substantially equal to a periodicity of the array of louvres.

The louvres may extend longitudinally in the first dimension, and may be spaced apart in the second dimension. The separation between adjacent louvre slats in the second dimension may be defined as the pitch. In some arrangements the pitch may be the same for all louvre slats of the array. It may be said that the spacing or periodicity of the louvres is uniform for the array. In other arrangements, the pitch may vary between slats of the array, such as from a first end to a second end of the array. It may be said that the spacing or periodicity of the slats of the array is non-uniform for the array.

The louvres of the array of louvres may comprise a material having one or more of: high absorption; high attenuation; low specular reflectivity, and high diffusivity of light. The person skilled in the art of optics appreciates what constitutes “high” and “low” in relation to the optical properties of a material. In some embodiments, the term “high” means greater than 80% such as greater than 90% or 95% and the term “low” means less than 20% such as less than 10% or 5%. For example, the term “high attenuation” may mean that the intensity of incident light (e.g. sunlight) is attenuated (i.e. reduced) by at least 95%.

The louvre structure comprises a one-dimensional array of parallel longitudinal slats, each slat having a length, width (height) and a thickness. In embodiments, the louvres/louvre slats have fixed positions in the array and remain static in use. In some embodiments, the slats have a uniform thickness. In other embodiments, the slats may vary in thickness, for example the thickness may be tapered along their width from the proximal end/edge to the distal end/edge.

In some arrangements, the angle of the (sidewalls of the) louvres/louvre slats may be uniform (i.e. constant) across the array. In other arrangements, the angle of the (sidewalls of the) louvres/louvre slats may vary across the array, such as from a first end to a second end of the array.

The louvres/slats (or slat sidewalls) may be orientated so as to be aligned with/parallel to a central or “gut” ray of the HUD-light received at the intermediate layer. In this way, the louvres may be arranged to substantially transmissive to the HUD-light. Typically, the HUD-light received at the intermediate layer will be non-parallel to the normal of the component/light control device. So, the louvres/slats (or slat sidewalls) may be orientated (inclined) at a (non-zero) angle to said normal.

In some embodiments, the array of louvres comprises louvres/louvre slats that are spatially separated by air. In other embodiments, the array of louvres includes a transparent structure between adjacent louvres/louvre slats of the array. The transparent structure may improve the structural and functional integrity of the louvre structure, so that it is more robust (less easily damaged) and may be more easily cleaned. In some such embodiments, the array of louvres may be embedded in the transparent structure. For example, the intermediate layer may comprise a film or microfilm comprising the array of (micro) louvres embedded in a transparent material. Such an intermediate layer may be suitable for high speed (optionally, continuous) mass-production methods of the reflection suppression device.

In some embodiments, the light control device further comprises a second layer. The second layer comprises a second serrated structure. The intermediate layer may be sandwiched between the first and second layer. The light control device may be arranged to receive HUD-light at the second layer first. The light control device may be arranged such that the HUD-light passes from the second layer to the intermediate layer and, optionally, on to the first layer. The HUD-light may then be transmitted from the light control device via the active faces of the first serrated structure of the first layer.

The second serrated structure may comprise an array of second active faces and a respective array of second passive faces. In some embodiments, each of the second passive faces may comprise a first layer having at least one structural feature configured to suppress the specular reflection of ambient light incident thereon. Each of the second passive faces of the second layer may comprise a first layer as described above in relation to the component of the first layer/first aspect. The second active faces and the second passive faces may be arranged in an alternating configuration. The second serrated structure may comprise a plurality of second serrations, arranged in an array. The plurality of second serrations may be elongated in the first dimension and the array may extend in the second dimension. Each second serration may comprise a second active face and a respective second passive face. Each second active face may have a corresponding active face of the first surface. In other words, there may be pairs of active faces in the first and second layers. In some embodiments, the active faces may be arranged such that, when the light control device is in use, HUD-light propagating through each second active face of the second layer also propagates through the active face of the first layer that is paired with the respective active face of the second layer.

In a third aspect, there is provided a head-up display for a vehicle. The head-up display comprises an optical component. The optical component has a reflective surface. The reflective surface is arranged, during head-up display operation, in a configuration that is conducive to sunlight glare. In some embodiments, the head-up display further comprises a light control device as defined in the third aspect. The light control device is arranged to receive ambient light on an optical path to the reflective surface of the optical component. The light control device may be arranged such that HUD-light may be receivable at the light control device from the optical component. The light control device may be arranged such that HUD-light is transmissible through the active faces of the first serrated structure of the light control layer.

In some embodiment, the optical component is a waveguide. The waveguide may be substantially planar. In some embodiments, the waveguide is arranged during head-up display operation in a substantially flat configuration relative to ground (e.g. horizontal).

In a fourth aspect, there is provided a method of processing a component for a light control device. The component comprises a first serrated structure having an array of active faces and a respective array of passive faces. The component may be a component as defined in the first aspect. The method comprises forming a first layer on each passive face. The first layer comprises at least one structural feature configured to suppress reflection of ambient light incident thereon.

In some embodiments, the step of forming each first layer comprises forming a pattern on each passive face. This may comprise embossing the pattern on each passive face. The embossing may comprise hot embossing.

In some embodiments, the method comprises manufacturing the component. In some embodiments, the step of manufacturing the component comprises injection moulding the component. In such embodiments, the step of forming each first layer on each passive face may be performed during the injection moulding step. The injection mould used in the injection moulding process may comprise an array of patterned surfaces for forming the passive faces and the pattern on the passive faces simultaneously.

In some embodiments, the step of forming the first layer may comprise forming a porous polymer on each passive face. The inventors have found that methods for forming a porous polymer may advantageous allow for a straightforward means for accurately forming a patterned rough surface on each passive face. Furthermore, an advantage of forming the first layer as a porous polymer is that such methods do not require embossing equipment or a mould to be adapted to achieve the surface roughness. Such adaptations can be slow and expensive. Any changes to the pattern to be formed require the embossing equipment or mould to be changed (with further associated time and cost requirements). Such problems do not exists with methods for manufacturing porous polymers.

All of the methods for forming the first layer on the passive faces outlined in the present disclosure have the advantage that a first layer can be performed on each of the passive faces relatively quickly and in a single process. Thus, there may be no need to individually process each passive face individually.

In some embodiments, the step of forming each first layer comprises applying a polymer processing solution to the component by spraying or dip-coating the component.

In some embodiments, the polymer processing solution applied to the at least portion of the first surface comprises a solvent such as acetone. In some embodiments, the polymer processing solution further comprises a non-solvent such as water. In some embodiments, the polymer processing solution further comprises a dissolved polymer. Said polymer processing solution may be suitable for a non-solvent induced phase separation process. A phase separation process may preferably comprise dip-coating the component in the polymer processing solution. The method may further comprise evaporating the solvent from the polymer processing solution applied to the at least portion of the first surface. This may be such that phase separation between the polymer and the non-evaporated non-solvent forms a porous polymer layer having one or more structural features for suppressing specular reflections of ambient light incident thereon. The formed porous polymer may comprise a plurality of fibrils or a fibril network. The fibril network may be an isotropic fibril network.

In some embodiments, the polymer processing solution applied to the at least portion of the first surface comprises a plurality of monomers and a plurality of porogens. In such embodiments, the polymer processing solution may be suitable for forming a polymer when irradiated by electromagnetic radiation (E/M), for example infra-red (IR) or ultraviolet (UV). In other words, the polymer processing solution by E/M curable such as IR or UV curable. In some embodiments, the method further comprises irradiating the applied polymer processing solution to form a cured polymer. The method may further comprise only irradiating the polymer processing solution applied to the passive faces. This may be achieved by appropriately orientating the first component with respect to the source of radiation. Thus, the polymer processing solution may only be cured on the passive surfaces. The irradiation may cause a phase separation of the porogens and the cured polymer. The step of irradiating the applied polymer processing solution may comprise irradiating the applied polymer processing solution with E/M radiation such as IR or UV radiation. In some embodiments, the method further comprises, after the irradiation step, submerging the cured polymer in a solvent. This may extract the porogens, leaving a porous first layer on the passive faces of the first serrated structure. The submerging step may also remove the polymer processing solution from the active faces (which may not have cured, as above).

In some embodiments, the method further comprises the step of polishing the active faces. This may be performed before or after the step of forming the first layer on each of the passive faces.

In some embodiments, the method further comprises applying or forming a second layer on to each first layer (after the first layer has been formed). The second layer may be a coating. The second layer may be substantially non-transmissive to one or more wavelengths of visible light. The second layer may be a paint such that the step of applying or forming the second layer comprises painting each of the first layers.

In the present disclosure, the term “replica” is merely used to reflect that spatially modulated light is divided such that a complex light field is directed along a plurality of different optical paths. The word “replica” is used to refer to each occurrence or instance of the complex light field after a replication event-such as a partial reflection-transmission by a pupil expander. Each replica travels along a different optical path. Some embodiments of the present disclosure relate to propagation of light that is encoded with a hologram, not an image—i.e., light that is spatially modulated with a hologram of an image, not the image itself. It may therefore be said that a plurality of replicas of the hologram are formed. The person skilled in the art of holography will appreciate that the complex light field associated with propagation of light encoded with a hologram will change with propagation distance. Use herein of the term “replica” is independent of propagation distance and so the two branches or paths of light associated with a replication event are still referred to as “replicas” of each other even if the branches are a different length, such that the complex light field has evolved differently along each path. That is, two complex light fields are still considered “replicas” in accordance with this disclosure even if they are associated with different propagation distances-providing they have arisen from the same replication event or series of replication events.

A “diffracted light field” or “diffractive light field” in accordance with this disclosure is a light field formed by diffraction. A diffracted light field may be formed by illuminating a corresponding diffractive pattern. In accordance with this disclosure, an example of a diffractive pattern is a hologram and an example of a diffracted light field is a holographic light field or a light field forming a holographic reconstruction of an image. The holographic light field forms a (holographic) reconstruction of an image on a replay plane. The holographic light field that propagates from the hologram to the replay plane may be said to comprise light encoded with the hologram or light in the hologram domain. A diffracted light field is characterized by a diffraction angle determined by the smallest feature size of the diffractive structure and the wavelength of the light (of the diffracted light field). In accordance with this disclosure, it may also be said that a “diffracted light field” is a light field that forms a reconstruction on a plane spatially separated from the corresponding diffractive structure. An optical system is disclosed herein for propagating a diffracted light field from a diffractive structure to a viewer. The diffracted light field may form an image.

The term “hologram” is used to refer to the recording which contains amplitude information or phase information, or some combination thereof, regarding the object. The term “holographic reconstruction” is used to refer to the optical reconstruction of the object which is formed by illuminating the hologram. The system disclosed herein is described as a “holographic projector” because the holographic reconstruction is a real image and spatially-separated from the hologram. The term “replay field” is used to refer to the 2D area within which the holographic reconstruction is formed and fully focused. If the hologram is displayed on a spatial light modulator comprising pixels, the replay field will be repeated in the form of a plurality diffracted orders wherein each diffracted order is a replica of the zeroth-order replay field. The zeroth-order replay field generally corresponds to the preferred or primary replay field because it is the brightest replay field. Unless explicitly stated otherwise, the term “replay field” should be taken as referring to the zeroth-order replay field. The term “replay plane” is used to refer to the plane in space containing all the replay fields. The terms “image”, “replay image” and “image region” refer to areas of the replay field illuminated by light of the holographic reconstruction. In some embodiments, the “image” may comprise discrete spots which may be referred to as “image spots” or, for convenience only, “image pixels”.

The terms “encoding”, “writing” or “addressing” are used to describe the process of providing the plurality of pixels of the SLM with a respective plurality of control values which respectively determine the modulation level of each pixel. It may be said that the pixels of the SLM are configured to “display” a light modulation distribution in response to receiving the plurality of control values. Thus, the SLM may be said to “display” a hologram and the hologram may be considered an array of light modulation values or levels.

It has been found that a holographic reconstruction of acceptable quality can be formed from a “hologram” containing only phase information related to the Fourier transform of the original object. Such a holographic recording may be referred to as a phase-only hologram. Embodiments relate to a phase-only hologram but the present disclosure is equally applicable to amplitude-only holography.

The present disclosure is also equally applicable to forming a holographic reconstruction using amplitude and phase information related to the Fourier transform of the original object. In some embodiments, this is achieved by complex modulation using a so-called fully complex hologram which contains both amplitude and phase information related to the original object. Such a hologram may be referred to as a fully-complex hologram because the value (grey level) assigned to each pixel of the hologram has an amplitude and phase component. The value (grey level) assigned to each pixel may be represented as a complex number having both amplitude and phase components. In some embodiments, a fully-complex computer-generated hologram is calculated.

Reference may be made to the phase value, phase component, phase information or, simply, phase of pixels of the computer-generated hologram or the spatial light modulator as shorthand for “phase-delay”. That is, any phase value described is, in fact, a number (e.g. in the range 0 to 2π) which represents the amount of phase retardation provided by that pixel. For example, a pixel of the spatial light modulator described as having a phase value of π/2 will retard the phase of received light by π/2 radians. In some embodiments, each pixel of the spatial light modulator is operable in one of a plurality of possible modulation values (e.g. phase delay values). The term “grey level” may be used to refer to the plurality of available modulation levels. For example, the term “grey level” may be used for convenience to refer to the plurality of available phase levels in a phase-only modulator even though different phase levels do not provide different shades of grey. The term “grey level” may also be used for convenience to refer to the plurality of available complex modulation levels in a complex modulator.

The hologram therefore comprises an array of grey levels—that is, an array of light modulation values such as an array of phase-delay values or complex modulation values. The hologram is also considered a diffractive pattern because it is a pattern that causes diffraction when displayed on a spatial light modulator and illuminated with light having a wavelength comparable to, generally less than, the pixel pitch of the spatial light modulator. Reference is made herein to combining the hologram with other diffractive patterns such as diffractive patterns functioning as a lens or grating. For example, a diffractive pattern functioning as a grating may be combined with a hologram to translate the replay field on the replay plane or a diffractive pattern functioning as a lens may be combined with a hologram to focus the holographic reconstruction on a replay plane in the near field.

Although different embodiments and groups of embodiments may be disclosed separately in the detailed description which follows, any feature of any embodiment or group of embodiments may be combined with any other feature or combination of features of any embodiment or group of embodiments. That is, all possible combinations and permutations of features disclosed in the present disclosure are envisaged.

### BRIEF DESCRIPTION OF THE DRAWINGS

Specific embodiments are described by way of example only with reference to the following figures:

FIG. 1 is a schematic showing a reflective SLM producing a holographic reconstruction on a screen;

FIG. 2 shows an image for projection comprising eight image areas/components, V1 to V8, and cross-sections of the corresponding hologram channels, H1-H8;

FIG. 3 shows a hologram displayed on an LCOS that directs light into a plurality of discrete areas;

FIG. 4 shows a system, including a display device that displays a hologram that has been calculated as illustrated in FIGS. 2 and 3;

FIG. 5A shows a perspective view of a first example two-dimensional pupil expander comprising two replicators each comprising pairs of stacked surfaces;

FIG. 5B shows a perspective view of a first example two-dimensional pupil expander comprising two replicators each in the form of a solid waveguide;

FIG. 6 is a schematic side view of a reflection suppression device in combination with a turning layer;

FIG. 7 is a schematic perspective view of the first reflection suppression device of FIG. 6;

FIG. 8A is a schematic cross-sectional view of a portion of the first reflection suppression device of FIG. 6, the cross-section being in a first (y-z) plane;

FIG. 8B is a schematic cross-sectional view of a portion of the first reflection suppression device of FIG. 6, the cross-section being in a second (x-z) plane;

FIG. 9 is a schematic cross-sectional close-up view of a portion of the first reflection suppression device of FIG. 6, showing a mechanism by which ambient light forms glare;

FIG. 10 is a schematic cross-sectional close-up view of a portion of a modified version of the reflection suppression device, comprising a painted coating on passive faces of a serrated surface;

FIG. 11 is a schematic cross-sectional view corresponding to that of FIG. 10, but FIG. 11 shows a mechanism by which ambient light can form glare;

FIG. 12 is a schematic cross-sectional view of an improved reflection suppression device comprising a component according to the present disclosure comprising a first layer on the passive faces arranged to suppress reflections;

FIG. 13 is a schematic close-up view of a porous polymer forming the first layer, the porous polymer comprising a plurality of pore; and

FIG. 14 is schematic close-up view of another porous polymer forming the first layer, the porous polymer comprising a plurality of fibres.

The same reference numbers will be used throughout the drawings to refer to the same or like parts.

### DETAILED DESCRIPTION OF EMBODIMENTS

The present invention is not restricted to the embodiments described in the following but extends to the full scope of the appended claims. That is, the present invention may be embodied in different forms and should not be construed as limited to the described embodiments, which are set out for the purpose of illustration.

Terms of a singular form may include plural forms unless specified otherwise.

A structure described as being formed at an upper portion/lower portion of another structure or on/under the other structure should be construed as including a case where the structures contact each other and, moreover, a case where a third structure is disposed there between.

In describing a time relationship—for example, when the temporal order of events is described as “after”, “subsequent”, “next”, “before” or suchlike—the present disclosure should be taken to include continuous and non-continuous events unless otherwise specified. For example, the description should be taken to include a case which is not continuous unless wording such as “just”, “immediate” or “direct” is used.

Although the terms “first”, “second”, etc. may be used herein to describe various elements, these elements are not to be limited by these terms. These terms are only used to distinguish one element from another. For example, a first element could be termed a second element, and, similarly, a second element could be termed a first element, without departing from the scope of the appended claims.

Features of different embodiments may be partially or overall coupled to or combined with each other, and may be variously inter-operated with each other. Some embodiments may be carried out independently from each other, or may be carried out together in co-dependent relationship.

In the present disclosure, the term “substantially” when applied to a structural units of an apparatus may be interpreted as the technical feature of the structural units being produced within the technical tolerance of the method used to manufacture it.

### Conventional Optical Configuration for Holographic Projection

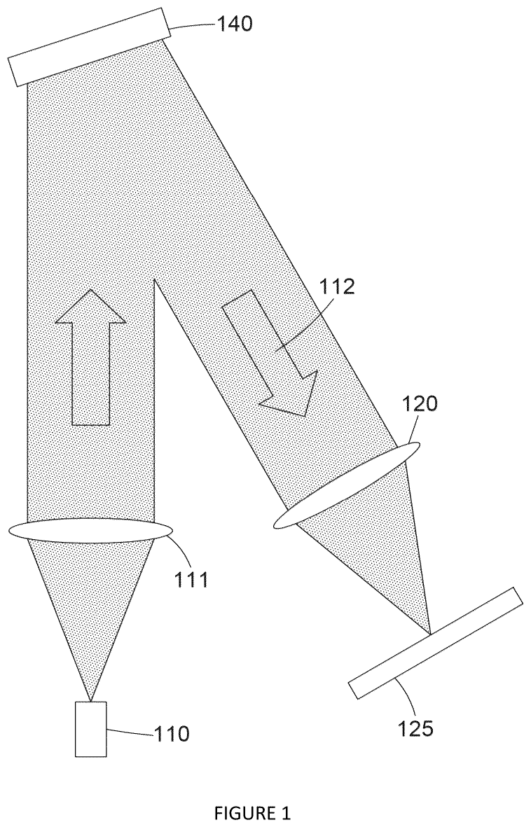

FIG. 1 shows an embodiment in which a computer-generated hologram is encoded on a single spatial light modulator. The computer-generated hologram is a Fourier transform of the object for reconstruction. It may therefore be said that the hologram is a Fourier domain or frequency domain or spectral domain representation of the object. In this embodiment, the spatial light modulator is a reflective liquid crystal on silicon, “LCOS”, device. The hologram is encoded on the spatial light modulator and a holographic reconstruction is formed at a replay field, for example, a light receiving surface such as a screen or diffuser.

A light source 110, for example a laser or laser diode, is disposed to illuminate the SLM 140 via a collimating lens 111. The collimating lens causes a generally planar wavefront of light to be incident on the SLM. In FIG. 1, the direction of the wavefront is off-normal (e.g. two or three degrees away from being truly orthogonal to the plane of the transparent layer). However, in other embodiments, the generally planar wavefront is provided at normal incidence and a beam splitter arrangement is used to separate the input and output optical paths. In the embodiment shown in FIG. 1, the arrangement is such that light from the light source is reflected off a mirrored rear surface of the SLM and interacts with a light-modulating layer to form an exit wavefront 112. The exit wavefront 112 is applied to optics including a Fourier transform lens 120, having its focus at a screen 125. More specifically, the Fourier transform lens 120 receives a beam of modulated light from the SLM 140 and performs a frequency-space transformation to produce a holographic reconstruction at the screen 125.

Notably, in this type of holography, each pixel of the hologram contributes to the whole reconstruction. There is not a one-to-one correlation between specific points (or image pixels) on the replay field and specific light-modulating elements (or hologram pixels). In other words, modulated light exiting the light-modulating layer is distributed across the replay field.

In these embodiments, the position of the holographic reconstruction in space is determined by the dioptric (focusing) power of the Fourier transform lens. In the embodiment shown in FIG. 1, the Fourier transform lens is a physical lens. That is, the Fourier transform lens is an optical Fourier transform lens and the Fourier transform is performed optically. Any lens can act as a Fourier transform lens but the performance of the lens will limit the accuracy of the Fourier transform it performs. The skilled person understands how to use a lens to perform an optical Fourier transform In some embodiments of the present disclosure, the lens of the viewer's eye performs the hologram to image transformation.

### Hologram Calculation

In some embodiments, the computer-generated hologram is a Fourier transform hologram, or simply a Fourier hologram or Fourier-based hologram, in which an image is reconstructed in the far field by utilising the Fourier transforming properties of a positive lens. The Fourier hologram is calculated by Fourier transforming the desired light field in the replay plane back to the lens plane. Computer-generated Fourier holograms may be calculated using Fourier transforms. Embodiments relate to Fourier holography and Gerchberg-Saxton type algorithms by way of example only. The present disclosure is equally applicable to Fresnel holography and Fresnel holograms which may be calculated by a similar method. In some embodiments, the hologram is a phase or phase-only hologram. However, the present disclosure is also applicable to holograms calculated by other techniques such as those based on point cloud methods.

In some embodiments, the hologram engine is arranged to exclude from the hologram calculation the contribution of light blocked by a limiting aperture of the display system. British patent application 2101666.2, filed 5 Feb. 2021 and incorporated herein by reference, discloses a first hologram calculation method in which eye-tracking and ray tracing are used to identify a sub-area of the display device for calculation of a point cloud hologram which eliminates ghost images. The sub-area of the display device corresponds with the aperture, of the present disclosure, and is used exclude light paths from the hologram calculation. British patent application 2112213.0, filed 26 Aug. 2021 and incorporated herein by reference, discloses a second method based on a modified Gerchberg-Saxton type algorithm which includes steps of light field cropping in accordance with pupils of the optical system during hologram calculation. The cropping of the light field corresponds with the determination of a limiting aperture of the present disclosure. British patent application 2118911.3, filed 23 Dec. 2021 and also incorporated herein by reference, discloses a third method of calculating a hologram which includes a step of determining a region of a so-called extended modulator formed by a hologram replicator. The region of the extended modulator is also an aperture in accordance with this disclosure.

In some embodiments, there is provided a real-time engine arranged to receive image data and calculate holograms in real-time using the algorithm. In some embodiments, the image data is a video comprising a sequence of image frames. In other embodiments, the holograms are pre-calculated, stored in computer memory and recalled as needed for display on a SLM. That is, in some embodiments, there is provided a repository of predetermined holograms.

### Large Field of View Using Small Display Device

Broadly, the present disclosure relates to image projection. It relates to a method of image projection and an image projector which comprises a display device. The present disclosure also relates to a projection system comprising the image projector and a viewing system, in which the image projector projects or relays light from the display device to the viewing system. The present disclosure is equally applicable to a monocular and binocular viewing system. The viewing system may comprise a viewer's eye or eyes. The viewing system comprises an optical element having optical power (e.g., lens/es of the human eye) and a viewing plane (e.g., retina of the human eye/s). The projector may be referred to as a ‘light engine’. The display device and the image formed (or perceived) using the display device are spatially separated from one another. The image is formed, or perceived by a viewer, on a display plane. In some embodiments, the image is a virtual image and the display plane may be referred to as a virtual image plane. In other examples, the image is a real image formed by holographic reconstruction and the image is projected or relayed to the viewing plane. In these other examples, spatially modulated light of an intermediate holographic reconstruction formed either in free space or on a screen or other light receiving surface between the display device and the viewer, is propagated to the viewer. In both cases, an image is formed by illuminating a diffractive pattern (e.g., hologram or kinoform) displayed on the display device.

The display device comprises pixels. The pixels of the display may display a diffractive pattern or structure that diffracts light. The diffracted light may form an image at a plane spatially separated from the display device. In accordance with well-understood optics, the magnitude of the maximum diffraction angle is determined by the size of the pixels and other factors such as the wavelength of the light.

In embodiments, the display device is a spatial light modulator such as liquid crystal on silicon (“LCOS”) spatial light modulator (SLM). Light propagates over a range of diffraction angles (for example, from zero to the maximum diffractive angle) from the LCOS, towards a viewing entity/system such as a camera or an eye. In some embodiments, magnification techniques may be used to increase the range of available diffraction angles beyond the conventional maximum diffraction angle of an LCOS.

In some embodiments, the (light of a) hologram itself is propagated to the eyes. For example, spatially modulated light of the hologram (that has not yet been fully transformed to a holographic reconstruction, i.e. image)—that may be informally said to be “encoded” with/by the hologram—is propagated directly to the viewer's eyes. A real or virtual image may be perceived by the viewer. In these embodiments, there is no intermediate holographic reconstruction/image formed between the display device and the viewer. It is sometimes said that, in these embodiments, the lens of the eye performs a hologram-to-image conversion or transform. The projection system, or light engine, may be configured so that the viewer effectively looks directly at the display device.

Reference is made herein to a “light field” which is a “complex light field”. The term “light field” merely indicates a pattern of light having a finite size in at least two orthogonal spatial directions, e.g. x and y. The word “complex” is used herein merely to indicate that the light at each point in the light field may be defined by an amplitude value and a phase value, and may therefore be represented by a complex number or a pair of values. For the purpose of hologram calculation, the complex light field may be a two-dimensional array of complex numbers, wherein the complex numbers define the light intensity and phase at a plurality of discrete locations within the light field.

In accordance with the principles of well-understood optics, the range of angles of light propagating from a display device that can be viewed, by an eye or other viewing entity/system, varies with the distance between the display device and the viewing entity. At a 1 metre viewing distance, for example, only a small range of angles from an LCOS can propagate through an eye's pupil to form an image at the retina for a given eye position. The range of angles of light rays that are propagated from the display device, which can successfully propagate through an eye's pupil to form an image at the retina for a given eye position, determines the portion of the image that is ‘visible’ to the viewer. In other words, not all parts of the image are visible from any one point on the viewing plane (e.g., any one eye position within a viewing window such as eye-box.)

In some embodiments, the image perceived by a viewer is a virtual image that appears upstream of the display device—that is, the viewer perceives the image as being further away from them than the display device. Conceptually, it may therefore be considered that the viewer is looking at a virtual image through an ‘display device-sized window’, which may be very small, for example 1 cm in diameter, at a relatively large distance, e.g., 1 metre. And the user will be viewing the display device-sized window via the pupil(s) of their eye(s), which can also be very small. Accordingly, the field of view becomes small and the specific angular range that can be seen depends heavily on the eye position, at any given time.

A pupil expander addresses the problem of how to increase the range of angles of light rays that are propagated from the display device that can successfully propagate through an eye's pupil to form an image. The display device is generally (in relative terms) small and the projection distance is (in relative terms) large. In some embodiments, the projection distance is at least one—such as, at least two—orders of magnitude greater than the diameter, or width, of the entrance pupil and/or aperture of the display device (i.e., size of the array of pixels).

Use of a pupil expander increases the viewing area (i.e., user's eye-box) laterally, thus enabling some movement of the eye/s to occur, whilst still enabling the user to see the image. As the skilled person will appreciate, in an imaging system, the viewing area (user's eye box) is the area in which a viewer's eyes can perceive the image. The present disclosure encompasses non-infinite virtual image distances—that is, near-field virtual images.

Conventionally, a two-dimensional pupil expander comprises one or more one-dimensional optical waveguides each formed using a pair of opposing reflective surfaces, in which the output light from a surface forms a viewing window or eye-box. Light received from the display device (e.g., spatially modulated light from a LCOS) is replicated by the or each waveguide so as to increase the field of view (or viewing area) in at least one dimension. In particular, the waveguide enlarges the viewing window due to the generation of extra rays or “replicas” by division of amplitude of the incident wavefront.

The display device may have an active or display area having a first dimension that may be less than 10 cms such as less than 5 cms or less than 2 cms. The propagation distance between the display device and viewing system may be greater than 1 m such as greater than 1.5 m or greater than 2 m. The optical propagation distance within the waveguide may be up to 2 m such as up to 1.5 m or up to 1 m. The method may be capable of receiving an image and determining a corresponding hologram of sufficient quality in less than 20 ms such as less than 15 ms or less than 10 ms.

In some embodiments—described only by way of example of a diffracted or holographic light field in accordance with this disclosure—a hologram is configured to route light into a plurality of channels, each channel corresponding to a different part (i.e. sub-area) of an image. The channels formed by the diffractive structure are referred to herein as “hologram channels” merely to reflect that they are channels of light encoded by the hologram with image information. It may be said that the light of each channel is in the hologram domain rather than the image or spatial domain. In some embodiments, the hologram is a Fourier or Fourier transform hologram and the hologram domain is therefore the Fourier or frequency domain. The hologram may equally be a Fresnel or Fresnel transform hologram. The hologram may also be a point cloud hologram. The hologram is described herein as routing light into a plurality of hologram channels to reflect that the image that can be reconstructed from the hologram has a finite size and can be arbitrarily divided into a plurality of image sub-areas, wherein each hologram channel would correspond to each image sub-area. Importantly, the hologram of this example is characterised by how it distributes the image content when illuminated. Specifically and uniquely, the hologram divides the image content by angle. That is, each point on the image is associated with a unique light ray angle in the spatially modulated light formed by the hologram when illuminated—at least, a unique pair of angles because the hologram is two-dimensional. For the avoidance of doubt, this hologram behaviour is not conventional. The spatially modulated light formed by this special type of hologram, when illuminated, may be divided into a plurality of hologram channels, wherein each hologram channel is defined by a range of light ray angles (in two-dimensions). It will be understood from the foregoing that any hologram channel (i.e. sub-range of light ray angles) that may be considered in the spatially modulated light will be associated with a respective part or sub-area of the image. That is, all the information needed to reconstruct that part or sub-area of the image is contained within a sub-range of angles of the spatially modulated light formed from the hologram of the image. When the spatially modulated light is observed as a whole, there is not necessarily any evidence of a plurality of discrete light channels.

Nevertheless, the hologram may still be identified. For example, if only a continuous part or sub-area of the spatially modulated light formed by the hologram is reconstructed, only a sub-area of the image should be visible. If a different, continuous part or sub-area of the spatially modulated light is reconstructed, a different sub-area of the image should be visible. A further identifying feature of this type of hologram is that the shape of the cross-sectional area of any hologram channel substantially corresponds to (i.e. is substantially the same as) the shape of the entrance pupil although the size may be different—at least, at the correct plane for which the hologram was calculated. Each light/hologram channel propagates from the hologram at a different angle or range of angles. Whilst these are example ways of characterising or identifying this type of hologram, other ways may be used. In summary, the hologram disclosed herein is characterised and identifiable by how the image content is distributed within light encoded by the hologram. Again, for the avoidance of any doubt, reference herein to a hologram configured to direct light or angularly-divide an image into a plurality of hologram channels is made by way of example only and the present disclosure is equally applicable to pupil expansion of any type of holographic light field or even any type of diffractive or diffracted light field.

The system can be provided in a compact and streamlined physical form. This enables the system to be suitable for a broad range of real-world applications, including those for which space is limited and real-estate value is high. For example, it may be implemented in a head-up display (HUD) such as a vehicle or automotive HUD.

In accordance with the present disclosure, pupil expansion is provided for diffracted or diffractive light, which may comprise diverging ray bundles. The diffracted light field may be defined by a “light cone”. Thus, the size of the diffracted light field (as defined on a two-dimensional plane) increases with propagation distance from the corresponding diffractive structure (i.e. display device). It can be said that the pupil expander/s replicate the hologram or form at least one replica of the hologram, to convey that the light delivered to the viewer is spatially modulated in accordance with a hologram.

In some embodiments, two one-dimensional waveguide pupil expanders are provided, each one-dimensional waveguide pupil expander being arranged to effectively increase the size of the exit pupil of the system by forming a plurality of replicas or copies of the exit pupil (or light of the exit pupil) of the spatial light modulator. The exit pupil may be understood to be the physical area from which light is output by the system. It may also be said that each waveguide pupil expander is arranged to expand the size of the exit pupil of the system. It may also be said that each waveguide pupil expander is arranged to expand/increase the size of the eye box within which a viewer's eye can be located, in order to see/receive light that is output by the system.

### Light Channeling

The hologram formed in accordance with some embodiments, angularly-divides the image content to provide a plurality of hologram channels which may have a cross-sectional shape defined by an aperture of the optical system. The hologram is calculated to provide this channeling of the diffracted light field. In some embodiments, this is achieved during hologram calculation by considering an aperture (virtual or real) of the optical system, as described above.

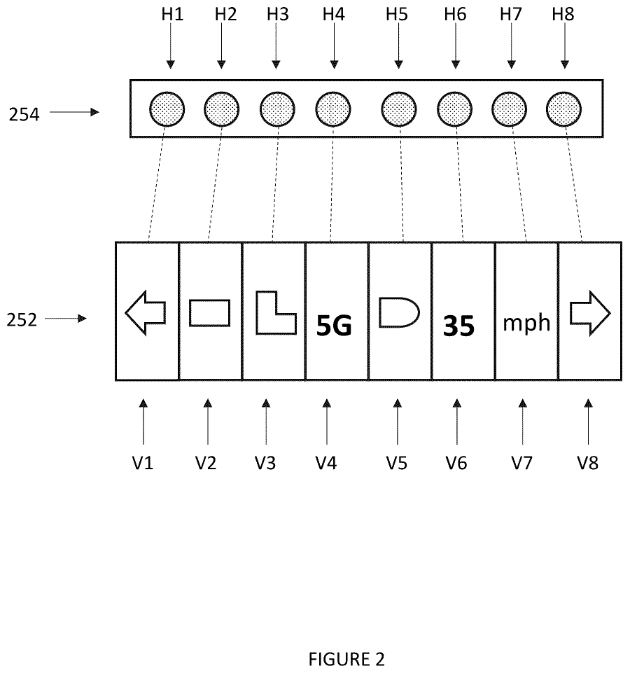

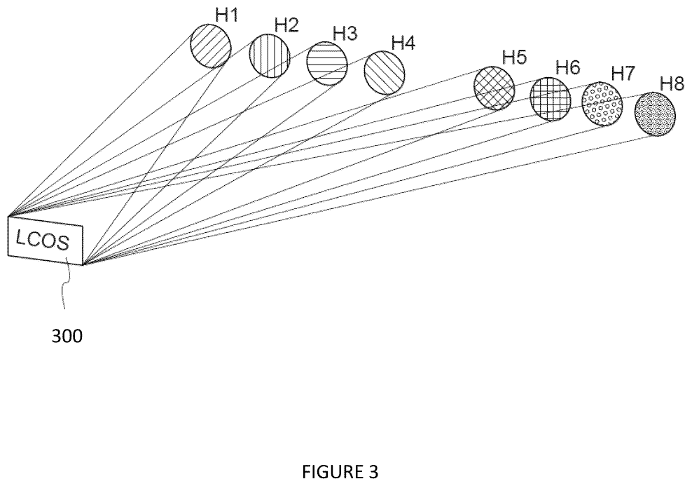

FIGS. 2 and 3 show an example of this type of hologram that may be used in conjunction with a pupil expander as disclosed herein. However, this example should not be regarded as limiting with respect to the present disclosure.

FIG. 2 shows an image 252 for projection comprising eight image areas/components, V1 to V8. FIG. 2 shows eight image components by way of example only and the image 252 may be divided into any number of components. FIG. 2 also shows an encoded light pattern 254 (i.e., hologram) that can reconstruct the image 252—e.g., when transformed by the lens of a suitable viewing system. The encoded light pattern 254 comprises first to eighth sub-holograms or components, H1 to H8, corresponding to the first to eighth image components/areas, V1 to V8. FIG. 2 further shows how a hologram may decompose the image content by angle. The hologram may therefore be characterised by the channeling of light that it performs. This is illustrated in FIG. 3. Specifically, the hologram in this example directs light into a plurality of discrete areas. The discrete areas are discs in the example shown but other shapes are envisaged. The size and shape of the optimum disc may, after propagation through the waveguide, be related to the size and shape of an aperture of the optical system such as the entrance pupil of the viewing system.

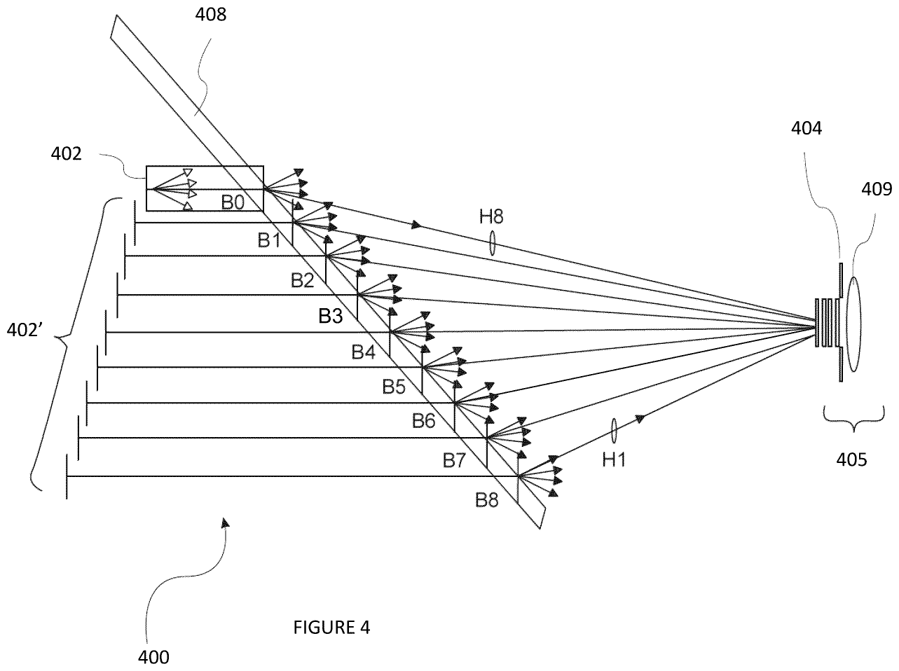

FIG. 4 shows a system 400, including a display device that displays a hologram that has been calculated as illustrated in FIGS. 2 and 3.

The system 400 comprises a display device, which in this arrangement comprises an LCOS 402. The LCOS 402 is arranged to display a modulation pattern (or ‘diffractive pattern’) comprising the hologram and to project light that has been holographically encoded towards an eye 405 that comprises a pupil that acts as an aperture 404, a lens 409, and a retina (not shown) that acts as a viewing plane. There is a light source (not shown) arranged to illuminate the LCOS 402. The lens 409 of the eye 405 performs a hologram-to-image transformation. The light source may be of any suitable type. For example, it may comprise a laser light source.

The viewing system 400 further comprises a waveguide 408 positioned between the LCOS 402 and the eye 405. The presence of the waveguide 408 enables all angular content from the LCOS 402 to be received by the eye, even at the relatively large projection distance shown. This is because the waveguide 508 acts as a pupil expander, in a manner that is well known and so is described only briefly herein.

In brief, the waveguide 408 shown in FIG. 4 comprises a substantially elongate formation. In this example, the waveguide 408 comprises an optical slab of refractive material, but other types of waveguide are also well known and may be used. The waveguide 408 is located so as to intersect the light cone (i.e., the diffracted light field) that is projected from the LCOS 402, for example at an oblique angle. In this example, the size, location, and position of the waveguide 408 are configured to ensure that light from each of the eight ray bundles, within the light cone, enters the waveguide 408. Light from the light cone enters the waveguide 408 via its first planar surface (located nearest the LCOS 402) and is guided at least partially along the length of the waveguide 408, before being emitted via its second planar surface, substantially opposite the first surface (located nearest the eye). As will be well understood, the second planar surface is partially reflective, partially transmissive. In other words, when each ray of light travels within the waveguide 408 from the first planar surface and hits the second planar surface, some of the light will be transmitted out of the waveguide 408 and some will be reflected by the second planar surface, back towards the first planar surface. The first planar surface is reflective, such that all light that hits it, from within the waveguide 408, will be reflected back towards the second planar surface. Therefore, some of the light may simply be refracted between the two planar surfaces of the waveguide 408 before being transmitted, whilst other light may be reflected, and thus may undergo one or more reflections, (or ‘bounces’) between the planar surfaces of the waveguide 408, before being transmitted.

FIG. 4 shows a total of nine “bounce” points, B0 to B8, along the length of the waveguide 408. Although light relating to all points of the image (V1-V8) as shown in FIG. 2 is transmitted out of the waveguide at each “bounce” from the second planar surface of the waveguide 408, only the light from one angular part of the image (e.g. light of one of V1 to V8) has a trajectory that enables it to reach the eye 405, from each respective “bounce” point, B0 to B8. Moreover, light from a different angular part of the image, V1 to V8, reaches the eye 405 from each respective “bounce” point. Therefore, each angular channel of encoded light reaches the eye only once, from the waveguide 408, in the example of FIG. 4.

The waveguide 408 forms a plurality of replicas of the hologram, at the respective “bounce” points B1 to B8 along its length, corresponding to the direction of pupil expansion. As shown in FIG. 4, the plurality of replicas may be extrapolated back, in a straight line, to a corresponding plurality of replica or virtual display devices 402′. This process corresponds to the step of “unfolding” an optical path within the waveguide, so that a light ray of a replica is extrapolated back to a “virtual surface” without internal reflection within the waveguide. Thus, the light of the expanded exit pupil may be considered to originate from a virtual surface (also called an “extended modulator” herein) comprising the display device 402 and the replica display devices 402′.

Although virtual images, which require the eye to transform received modulated light in order to form a perceived image, have generally been discussed herein, the methods and arrangements described herein can be applied to real images.

### Two-Dimensional Pupil Expansion

Whilst the arrangement shown in FIG. 4 includes a single waveguide that provides pupil expansion in one dimension, pupil expansion can be provided in more than one dimension, for example in two dimensions. Moreover, whilst the example in FIG. 4 uses a hologram that has been calculated to create channels of light, each corresponding to a different portion of an image, the present disclosure and the systems that are described herebelow are not limited to such a hologram type.

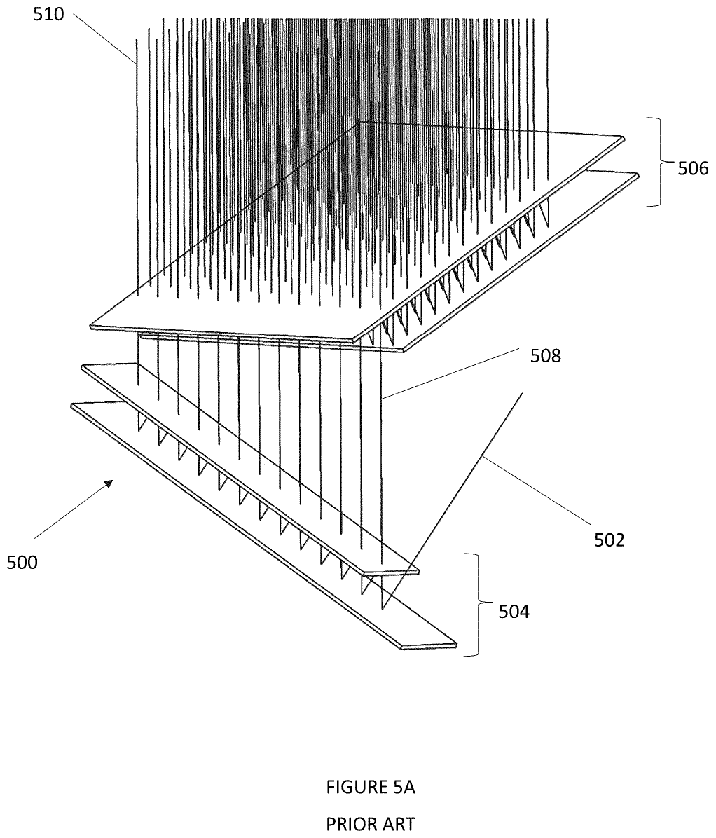

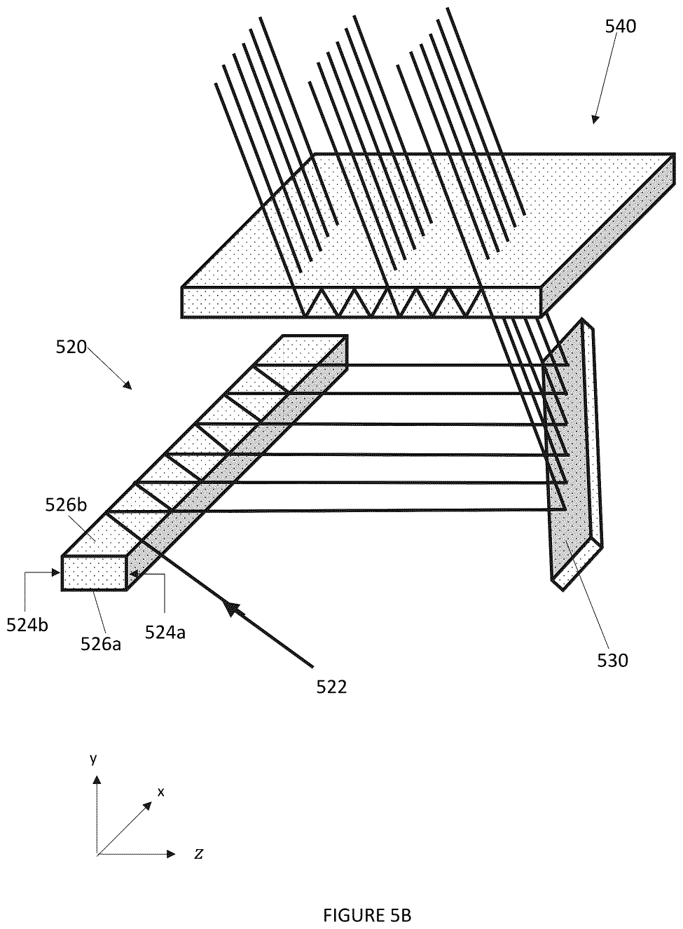

FIG. 5A shows a perspective view of a system 500 comprising two replicators, 504, 506 arranged for expanding a light beam 502 in two dimensions.

In the system 500 of FIG. 5A, the first replicator 504 comprises a first pair of surfaces, stacked parallel to one another, and arranged to provide replication—or, pupil expansion—in a similar manner to the waveguide 408 of FIG. 4. The first pair of surfaces are similarly (in some cases, identically) sized and shaped to one another and are substantially elongate in one direction. The collimated light beam 502 is directed towards an input on the first replicator 504. Due to a process of internal reflection between the two surfaces, and partial transmission of light from each of a plurality of output points on one of the surfaces (the upper surface, as shown in FIG. 5A), which will be familiar to the skilled reader, light of the light beam 502 is replicated in a first direction, along the length of the first replicator 504. Thus, a first plurality of replica light beams 508 is emitted from the first replicator 504, towards the second replicator 506.

The second replicator 506 comprises a second pair of surfaces stacked parallel to one another, arranged to receive each of the collimated light beams of the first plurality of light beams 508 and further arranged to provide replication—or, pupil expansion—by expanding each of those light beams in a second direction, substantially orthogonal to the first direction. The first pair of surfaces are similarly (in some cases, identically) sized and shaped to one another and are substantially rectangular. The rectangular shape is implemented for the second replicator in order for it to have length along the first direction, in order to receive the first plurality of light beams 508, and to have length along the second, orthogonal direction, in order to provide replication in that second direction. Due to a process of internal reflection between the two surfaces, and partial transmission of light from each of a plurality of output points on one of the surfaces (the upper surface, as shown in FIG. 5A), light of each light beam within the first plurality of light beams 508 is replicated in the second direction. Thus, a second plurality of light beams 510 is emitted from the second replicator 506, wherein the second plurality of light beams 510 comprises replicas of the input light beam 502 along each of the first direction and the second direction. Thus, the second plurality of light beams 510 may be regarded as comprising a two-dimensional grid, or array, of replica light beams.

Thus, it can be said that the first and second replicators 504, 505 of FIG. 5A combine to provide a two-dimensional replicator (or, “two-dimensional pupil expander”). Thus, the replica light beams 510 may be emitted along an optical path to an expanded eye-box of a display system, such as a head-up display.

In the system of FIG. 5A, the first replicator 504 is a waveguide comprising a pair of elongate rectilinear reflective surfaces, stacked parallel to one another, and, similarly, the second replicator 504 is a waveguide comprising a pair of rectangular reflective surfaces, stacked parallel to one another. In other systems, the first replicator may be a solid elongate rectilinear waveguide and the second replicator may be a solid planar rectangular shaped waveguide, wherein each waveguide comprises an optically transparent solid material such as glass. In this case, the pair of parallel reflective surfaces are formed by a pair of opposed major sidewalls optionally comprising respective reflective and reflective-transmissive surface coatings, familiar to the skilled reader.

FIG. 5B shows a perspective view of a system 500 comprising two replicators, 520, 540 arranged for replicating a light beam 522 in two dimensions, in which the first replicator is a solid elongated waveguide 520 and the second replicator is a solid planar waveguide 540.

In the system of FIG. 5B, the first replicator/waveguide 520 is arranged so that its pair of elongate parallel reflective surfaces 524a, 524b are perpendicular to the plane of the second replicator/waveguide 540. Accordingly, the system comprises an optical coupler arranged to couple light from an output port of first replicator 520 into an input port of the second replicator 540. In the illustrated arrangement, the optical coupler is a planar/fold mirror 530 arranged to fold or turn the optical path of light to achieve the required optical coupling from the first replicator to the second replicator. As shown in FIG. 5B, the mirror 530 is arranged to receive light—comprising a one-dimensional array of replicas extending in the first dimension—from the output port/reflective-transmissive surface 524a of the first replicator/waveguide 520. The mirror 530 is tilted so as to redirect the received light onto an optical path to an input port in the (fully) reflective surface of second replicator 540 at an angle to provide waveguiding and replica formation, along its length in the second dimension. It will be appreciated that the mirror 530 is one example of an optical element that can redirect the light in the manner shown, and that one or more other elements may be used instead, to perform this task.

In the illustrated arrangement, the (partially) reflective-transmissive surface 524a of the first replicator 520 is adjacent the input port of the first replicator/waveguide 520 that receives input beam 522 at an angle to provide waveguiding and replica formation, along its length in the first dimension. Thus, the input port of first replicator/waveguide 520 is positioned at an input end thereof at the same surface as the reflective-transmissive surface 524a. The skilled reader will understand that the input port of the first replicator/waveguide 520 may be at any other suitable position.

Accordingly, the arrangement of FIG. 5B enables the first replicator 520 and the mirror 530 to be provided as part of a first relatively thin layer in a plane in the first and third dimensions (illustrated as an x-z plane). In particular, the size or “height” of a first planar layer—in which the first replicator 520 is located—in the second dimension (illustrated as the y dimension) is reduced. The mirror 530 is configured to direct the light away from a first layer/plane, in which the first replicator 520 is located (i.e. the “first planar layer”), and direct it towards a second layer/plane, located above and substantially parallel to the first layer/plane, in which the second replicator 540 is located (i.e. a “second planar layer”). Thus, the overall size or “height” of the system—comprising the first and second replicators 520, 540 and the mirror 530 located in the stacked first and second planar layers in the first and third dimensions (illustrated as an x-z plane)—in the second dimension (illustrated as the y dimension) is compact. The skilled reader will understand that many variations of the arrangement of FIG. 5B for implementing the present disclosure are possible and contemplated.

The image projector may be arranged to project a diverging or diffracted light field. In some embodiments, the light field is encoded with a hologram. In some embodiments, the diffracted light field comprises diverging ray bundles. In some embodiments, the image formed by the diffracted light field is a virtual image.

In some embodiments, the first pair of parallel/complementary surfaces are elongate or elongated surfaces, being relatively long along a first dimension and relatively short along a second dimension, for example being relatively short along each of two other dimensions, with each dimension being substantially orthogonal to each of the respective others. The process of reflection/transmission of the light between/from the first pair of parallel surfaces is arranged to cause the light to propagate within the first waveguide pupil expander, with the general direction of light propagation being in the direction along which the first waveguide pupil expander is relatively long (i.e., in its “elongate” direction).

There is disclosed herein a system that forms an image using diffracted light and provides an eye-box size and field of view suitable for real-world application—e.g. in the automotive industry by way of a head-up display. The diffracted light is light forming a holographic reconstruction of the image from a diffractive structure—e.g. hologram such as a Fourier or Fresnel hologram. The use diffraction and a diffractive structure necessitates a display device with a high density of very small pixels (e.g. 1 micrometer)—which, in practice, means a small display device (e.g. 1 cm). The inventors have addressed a problem of how to provide 2D pupil expansion with a diffracted light field e.g. diffracted light comprising diverging (not collimated) ray bundles.

In some embodiments, the display system comprises a display device—such as a pixelated display device, for example a spatial light modulator (SLM) or Liquid Crystal on Silicon (LCoS) SLM—which is arranged to provide or form the diffracted or diverging light. In such aspects, the aperture of the spatial light modulator (SLM) is a limiting aperture of the system. That is, the aperture of the spatial light modulator—more specifically, the size of the area delimiting the array of light modulating pixels comprised within the SLM—determines the size (e.g. spatial extent) of the light ray bundle that can exit the system. In accordance with this disclosure, it is stated that the exit pupil of the system is expanded to reflect that the exit pupil of the system (that is limited by the small display device having a pixel size for light diffraction) is made larger or bigger or greater in spatial extend by the use of at least one pupil expander.

The diffracted or diverging light field may be said to have “a light field size”, defined in a direction substantially orthogonal to a propagation direction of the light field. Because the light is diffracted/diverging, the light field size increases with propagation distance.

In some embodiments, the diffracted light field is spatially-modulated in accordance with a hologram. In other words, in such aspects, the diffractive light field comprises a “holographic light field”. The hologram may be displayed on a pixelated display device. The hologram may be a computer-generated hologram (CGH). It may be a Fourier hologram or a Fresnel hologram or a point-cloud hologram or any other suitable type of hologram. The hologram may, optionally, be calculated so as to form channels of hologram light, with each channel corresponding to a different respective portion of an image that is intended to be viewed (or perceived, if it is a virtual image) by the viewer. The pixelated display device may be configured to display a plurality of different holograms, in succession or in sequence. Each of the aspects and embodiments disclosed herein may be applied to the display of multiple holograms.

The output port of the first waveguide pupil expander may be coupled to an input port of a second waveguide pupil expander. The second waveguide pupil expander may be arranged to guide the diffracted light field-including some of, preferably most of, preferably all of, the replicas of the light field that are output by the first waveguide pupil expander—from its input port to a respective output port by internal reflection between a third pair of parallel surfaces of the second waveguide pupil expander.

The first waveguide pupil expander may be arranged to provide pupil expansion, or replication, in a first direction and the second waveguide pupil expander may be arranged to provide pupil expansion, or replication, in a second, different direction. The second direction may be substantially orthogonal to the first direction. The second waveguide pupil expander may be arranged to preserve the pupil expansion that the first waveguide pupil expander has provided in the first direction and to expand (or, replicate) some of, preferably most of, preferably all of, the replicas that it receives from the first waveguide pupil expander in the second, different direction. The second waveguide pupil expander may be arranged to receive the light field directly or indirectly from the first waveguide pupil expander. One or more other elements may be provided along the propagation path of the light field between the first and second waveguide pupil expanders.

The first waveguide pupil expander may be substantially elongated and the second waveguide pupil expander may be substantially planar. The elongated shape of the first waveguide pupil expander may be defined by a length along a first dimension. The planar, or rectangular, shape of the second waveguide pupil expander may be defined by a length along a first dimension and a width, or breadth, along a second dimension substantially orthogonal to the first dimension. A size, or length, of the first waveguide pupil expander along its first dimension make correspond to the length or width of the second waveguide pupil expander along its first or second dimension, respectively. A first surface of the pair of parallel surfaces of the second waveguide pupil expander, which comprises its input port, may be shaped, sized, and/or located so as to correspond to an area defined by the output port on the first surface of the pair of parallel surfaces on the first waveguide pupil expander, such that the second waveguide pupil expander is arranged to receive each of the replicas output by the first waveguide pupil expander.

The first and second waveguide pupil expander may collectively provide pupil expansion in a first direction and in a second direction perpendicular to the first direction, optionally, wherein a plane containing the first and second directions is substantially parallel to a plane of the second waveguide pupil expander. In other words, the first and second dimensions that respectively define the length and breadth of the second waveguide pupil expander may be parallel to the first and second directions, respectively, (or to the second and first directions, respectively) in which the waveguide pupil expanders provide pupil expansion. The combination of the first waveguide pupil expander and the second waveguide pupil expander may be generally referred to as being a “pupil expander”.

It may be said that the expansion/replication provided by the first and second waveguide expanders has the effect of expanding an exit pupil of the display system in each of two directions. An area defined by the expanded exit pupil may, in turn define an expanded eye-box area, from which the viewer can receive light of the input diffracted or diverging light field. The eye-box area may be said to be located on, or to define, a viewing plane.

The two directions in which the exit pupil is expanded may be coplanar with, or parallel to, the first and second directions in which the first and second waveguide pupil expanders provide replication/expansion. Alternatively, in arrangements that comprise other elements such as an optical combiner, for example the windscreen (or, windshield) of a vehicle, the exit pupil may be regarded as being an exit pupil from that other element, such as from the windscreen. In such arrangements, the exit pupil may be non-coplanar and non-parallel with the first and second directions in which the first and second waveguide pupil expanders provide replication/expansion. For example, the exit pupil may be substantially perpendicular to the first and second directions in which the first and second waveguide pupil expanders provide replication/expansion.

The viewing plane, and/or the eye-box area, may be non-coplanar or non-parallel to the first and second directions in which the first and second waveguide pupil expanders provide replication/expansion. For example, a viewing plane may be substantially perpendicular to the first and second directions in which the first and second waveguide pupil expanders provide replication/expansion.

In order to provide suitable launch conditions to achieve internal reflection within the first and second waveguide pupil expanders, an elongate dimension of the first waveguide pupil expander may be tilted relative to the first and second dimensions of the second waveguide pupil expander.

### Combiner Shape Compensation

An advantage of projecting a hologram to the eye-box is that optical compensation can be encoded in the hologram (see, for example, European patent 2936252 incorporated herein by herein). The present disclosure is compatible with holograms that compensate for the complex curvature of an optical combiner used as part of the projection system. In some embodiments, the optical combiner is the windscreen of a vehicle. Full details of this approach are provided in European patent 2936252 and are not repeated here because the detailed features of those systems and methods are not essential to the new teaching of this disclosure herein and are merely exemplary of configurations that benefit from the teachings of the present disclosure.

### Control Device

The present disclosure is also compatible with optical configurations that include a control device (e.g. light shuttering device) to control the delivery of light from a light channeling hologram to the viewer. The holographic projector may further comprise a control device arranged to control the delivery of angular channels to the eye-box position. British patent application 2108456.1, filed 14 Jun. 2021 and incorporated herein by reference, discloses the at least one waveguide pupil expander and control device. The reader will understand from at least this prior disclosure that the optical configuration of the control device is fundamentally based upon the eye-box position of the user and is compatible with any hologram calculation method that achieves the light channeling described herein. It may be said that the control device is a light shuttering or aperturing device. The light shuttering device may comprise a 1D array of apertures or windows, wherein each aperture or window independently switchable between a light transmissive and a light non-transmissive state in order to control the deliver of hologram light channels, and their replicas, to the eye-box. Each aperture or window may comprise a plurality of liquid crystal cells or pixels.

### Reflection Suppression Device

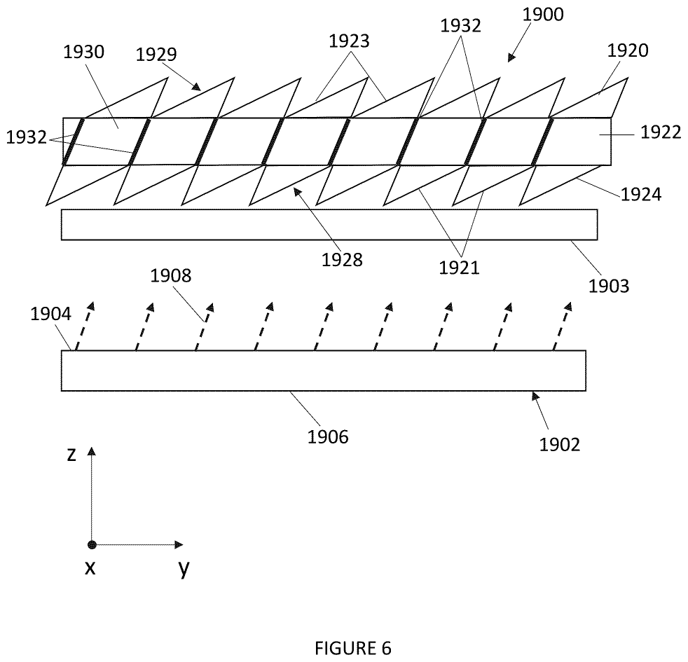

FIG. 6 shows a schematic side-view of features of a head-up display comprising a first reflection suppression device 1900. The head-up display of FIG. 6 comprises a waveguide 1902, a turning layer 1903, and the first reflection suppression device 1900. The head-up display further comprises a coherent light source (in this example, a laser) and a display device (in this example, a liquid crystal on silicon spatial light modulator) arranged to display a hologram of a picture. The light source and display device are not shown in FIG. 6. In use, the light source of the head-up display illuminates the display device such that light is spatially modulated in accordance with the hologram displayed on the display device, thus forming a holographic wavefront. The holographic wavefront is coupled into a first waveguide (not shown in FIG. 6) where the holographic wavefront is replicated in a first direction a plurality of times (as described previously) to form a one dimensional array of replicas which are then coupled into the waveguide 1902 (which is shown in FIG. 19). The waveguide 1902 comprises a pair of opposing surfaces. A first surface 1904 of the waveguide 1902 is partially transmissive-reflective. A second surface 1906 of the waveguide 1902 is reflective. The waveguide 1902 is arranged to waveguide the replicas of the holographic wavefront coupled in to the waveguide 1902 from the first waveguide between the pair of opposing surfaces. In this way, the holographic wavefront is replicated in a second direction (that is orthogonal to the first direction) a plurality of times (again, as described previously) to form a two dimensional array of replicas. The emission of replicas from the first surface 1904 is represented by the dotted arrows 1908 in FIG. 6. In the y-z plane, the replicas 1908 are angled with respect to a normal of the waveguide 1902 (i.e. the replicas are angled with respect to the z-direction in the y-z plane). In this example, the replicas 1908 of the holographic wavefront (at the first surface of the waveguide 1904) do not have a component on the x-z plane. So, as the skilled reader will appreciate, in a side view of the waveguide 1902 in the x-z plane, the replicas 1908 would appear to be emitted vertically up the page.

It should be understand that, although a holographic head-up display is described in relation to this example, that the glare suppression device 1900 could in fact be used with a conventional head-up display. In such cases, the light that propagates through the glare suppression device 1900 may be more conventional light, modulated in accordance with an image rather than a hologram.

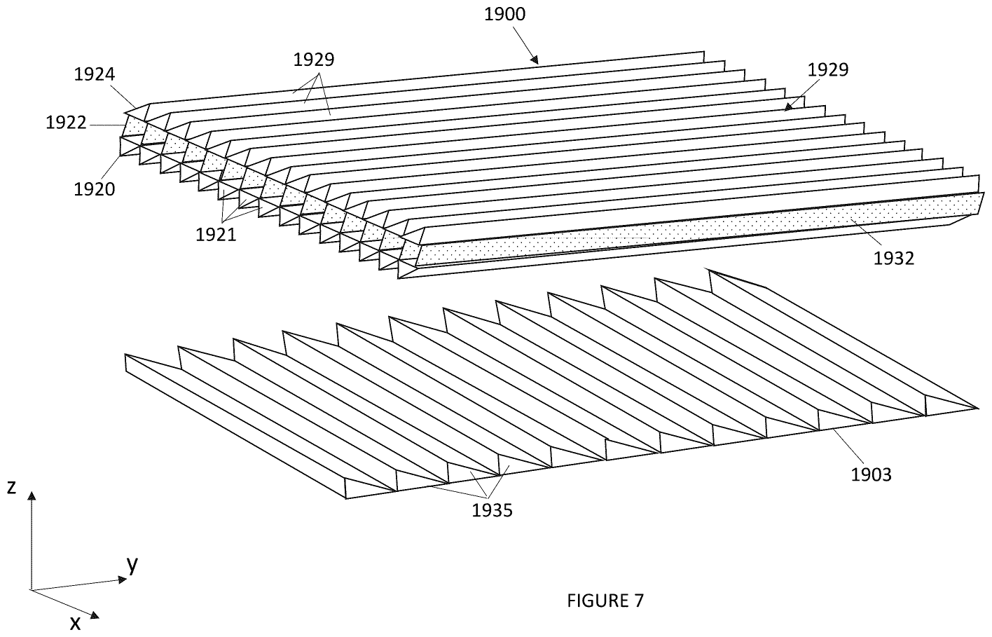

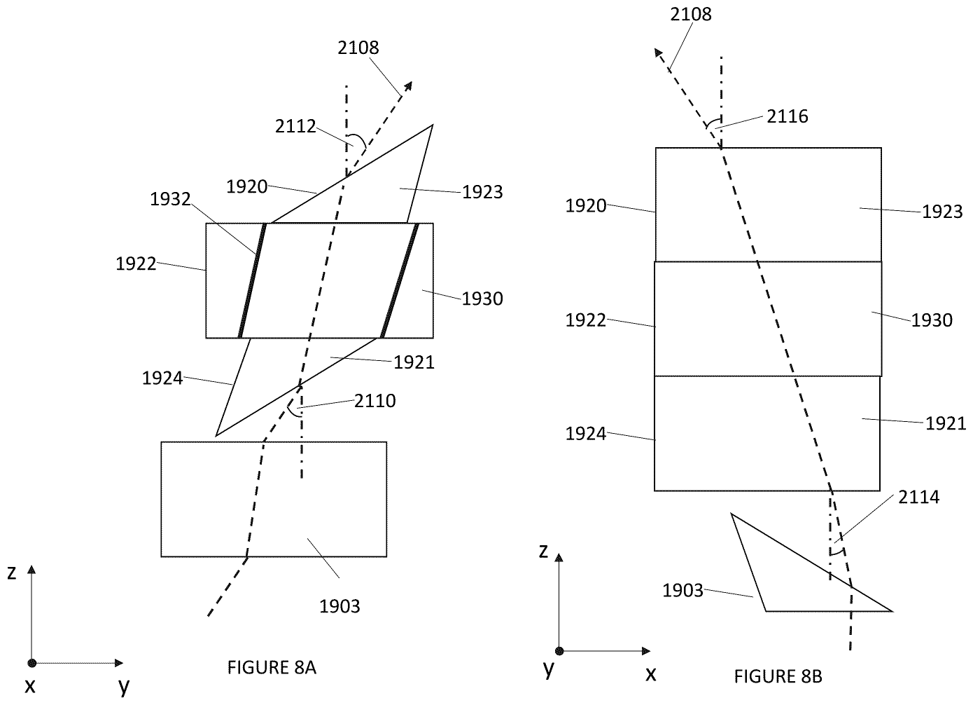

The replicas 1908 of the holographic wavefront emitted by the waveguide 1902 are received by the turning layer 1903 whereby the (replicas of) the holographic wavefront are turned by the turning layer 1903. The turned replicas 1908 are then received by the reflection suppression device 1900. The reflection suppression device 1900 comprises a layered structure which comprises a first layer 1920, an intermediate layer 1922, and a second layer 1924. The second layer 1924 is closest to the waveguide 1908/turning layer 1903. As such, the (replicas of) holographic wavefront (propagating through the reflection suppression device 1900) are received in turn by the second layer 1924, the intermediate layer 1922 and the first layer 1920. The specific arrangement of each of the layers of reflection suppression device 1900 will now be described in more detail with reference to FIGS. 7, 8A, and 8B.

FIG. 7 is schematic perspective view of the reflection suppression device 1900 in combination with the turning layer 1903. FIGS. 8A and 8B are different schematic cross-sectional views of a portion of the reflection suppression device 1900 and a corresponding portion of the turning layer 1903. FIGS. 8A and 8B shows the path of a holographic wavefront through the turning layer 1903 and the reflection suppression device 1900. The cross-section in FIG. 8A is in a first plane. The cross-section in FIG. 8B is in a second orthogonal to the first plane. Specifically, the first plane is the y-z plane and the second plane is the x-z plane. In other words, both the first and second plane contain a direction parallel to the surface normal of the waveguide 1902 (i.e. the z-direction). The cross-section of FIG. 8A is a very similar view to that of FIG. 6 (showing the replicas 1908 being emitted from waveguide 1908 at an angle with respect to the normal of the waveguide). The cross-section section of FIG. 8B instead shows the replicas 1908 as appearing to be emitted from the waveguide 1908 perpendicularly to the normal of the first surface 1904 of the waveguide 1902 (because, in this example, the replicas 1908 are emitted without a component being in the x-direction).

The second (bottom) layer 1924 comprises a second serrated surface 1928. An opposing face of the second layer 1924 is a non-serrated (planar) surface. The non-serrated surface of the second layer 1924 is in contact with, and adhered to, a surface of the intermediate layer 1922.

The second layer 1924 is a prismatic structure comprising a plurality/an array of prism elements 1921. The second layer 1924 is integrally formed such that the array of prism elements 1921 form a single component (forming the second layer 1924). The first serrated surface 1928 is defined by first and second surfaces of each of the prism elements 1921, thus forming a sawtooth-type structure when viewed in the y-z plane (as in FIGS. 6 and 8A, for example). The second layer 1924 is formed of a transparent material which, in this example, is a hard plastic (transparent) material. The second layer 1924 may have been manufactured by, for example, injection moulding, hot embossing, extruding or cutting a source of the transparent material.

The intermediate layer 1922 comprises a transparent material 1930 separating an array of individual louvres 1932. Each louvre 1932 is in the form of a slat, the length of which extends substantially in the x-direction (first dimension). The louvres 1932 are embedded in the transparent material 1930. In this example, the transparent material 1930 is a material having the same refractive index as the material forming the first layer 1920.

The first (top) layer 1920 comprises a first serrated surface 1929. An opposing face of the first layer 1920 is a non-serrated (planar) surface. The non-serrated surface of the first layer 1920 is in contact with, and adhered to, an opposite surface of the intermediate layer 1922 to the non-serrated surface of the second layer 1924.

The first layer 1920 is a prismatic structure comprising a plurality/an array of prism elements 1923. Like the second layer 1924, the first layer 1920 is integrally formed such that the array of prism elements 1923 form a single component (forming the first layer 1920). The first serrated surface 1929 is defined by first and second surfaces of each of the prism elements 1923, thus forming a sawtooth-type structure when viewed in the y-z plane (as in FIGS. 6 and 8A, for example). The second layer 1924 is formed of a transparent material which, in this example, is a hard plastic (transparent) material. In this example, the second layer 1924 is formed of the same transparent material as the first layer 1920 (or, at least, a material having the same refractive index as the transparent material of the first layer 1920). The second layer 1924 may have been manufactured by, for example, injection moulding, hot embossing, extruding or cutting a source of the transparent material.

A periodicity of the serrations of the second and first serrated surfaces 1928, 1929 is equal. Furthermore, the periodicity of the louvres 1932 in the array of louvres is equal to the periodicity of the serrations of the first and second serrated surfaces. Thus, for each serration of the second serrated surface 1928 of the second layer there is a corresponding serration of the first serrated surface 1929 of the first layer and a corresponding louvre 1932.

The first and second layers 1920, 1924 have a thickness in the z-direction. This thickness is defined between the respective serrated surface and non-serrated surface. As is clear from FIGS. 6 and 8A at least, the thickness of the first and second layers varies along the length of each serration (in the y-direction) because of the angled surfaces of each microstructure. The serrations of the first layer are angled the same in magnitude but opposite in direction to the serration of the second layer. Specifically, an angle a normal of each angled first surface of the second serrated surface 1928 to a normal of the waveguide is, in this example, equal in magnitude but opposite in polarity to an angle between each angled first surface of the first serrated surface 1929 to a normal of the waveguide.

Each of the second and first layers 1920, 1924 are formed of a transparent material which, in this example, has a refractive index greater than 1. In this example, each of the second first layers 1920 and 1924 are formed of polymethyl methacrylate (PMMA). Each of the second and first serrated surfaces 1928, 1929 form a transparent material/air interface. Light (in particular, the holographic wavefront 1908) propagating through the reflection suppression device will be turned, twice. A first turn will be provided by the first layer 1920 and a second turn will be provided by the second layer 1924. In this example, the shape of the serrations, and the refractive index of the transparent material, are selected such that the component of the first turn on the first plane (the y-z plane) is equal but opposite to the component of the second turn on the first plane (the y-z plane). However, this is not essential.

The second serrated surface 1928 of the reflection suppression device 1900 may be referred to herein as an input side of the reflection suppression device 1900 (because the second serrated surface 1928 receives the holographic wavefront). The first serrated surface 1929 of the reflection suppression device 1900 may be referred to herein as an output side of the reflection suppression device 1900 (because the first serrated surface 1929 emits the holographic wavefront once the holographic wavefront has propagated though the reflection suppression device 1900).

The turning layer 1903, in this example, also has a prismatic structure. However, the prism elements 1935 of the turning layer 1903 extend longitudinally in a direction that is orthogonal to the direction of extension of the prism elements of the first and second layers. Specifically, the prism elements 1935 extend longitudinally in the y-direction rather than the x-direction. As such, the prism elements 1935 are arranged to turn the holographic wavefront exclusively on the second plane (in the y-z plane) rather than on the first plane (the x-z plane).

### Glare Mitigation

The reflection suppression device 1900 is arranged to mitigate or suppress glare from being received at a viewing window or eye-box. In the absence of the reflection suppression device 1900, there is a risk that ambient light incident on the waveguide may be reflected and be received at the viewing window or eye-box. This ambient light may then be distracting. Said glare is suppressed by the reflection suppression device 1900 via a number of different mechanisms.

The array of louvres 1932 are formed of/consist of a light absorbing material. The array of louvres 1932 are angles such that the replicas 1908 of the holographic wavefront can substantially pass between the louvres 1932 without being absorbed. This is because each of the louvres is substantially parallel to a principal direction of propagation of the replicas 1908. However, ambient light passing through the reflection suppression device 1900 following a different propagation path (that is not parallel to the louvres) will tend to be incident on one of the louvres 1932. Said ambient light will be absorbed by said louvre 1932 and therefore will not be able to propagate on to the waveguide 1902 and so will not be reflected by the waveguide 1902 back to the viewing window/eye-box. As should be clear to the skilled reader, there will be a range of angles at which ambient light may be able to pass through the first layer 1920, between adjacent louvres 1932 of the intermediate layer 1922, and on through the second layer 1924. This range of angles will be defined by the pitch of the louvres 1932 and the shape/dimensions/orientation of the louvres 1932. After a first pass through the reflection suppression device, said ambient light may be reflected by the waveguide 1902 and returned back towards the reflection suppression device 1900 to pass through for a second time. On the second pass, the ambient light will pass through the second layer 1924 first before reaching the intermediate layer 1922, whereby the ambient light will generally be absorbed by one of the louvres 1932. Thus, even if the ambient light is not absorbed by the louvres 1932 on a first pass through the reflection suppression device, it will generally be absorbed by the louvres 1932 on the second pass.

The first serrated surface 1929 provides another mechanism for glare mitigation. In particular, the array of angled surfaces of the first serrated surface 1929 are arranged to specularly reflect ambient light incident thereon in a direction that is generally away from viewing window/eye-box.

### Additional Sources of Glare

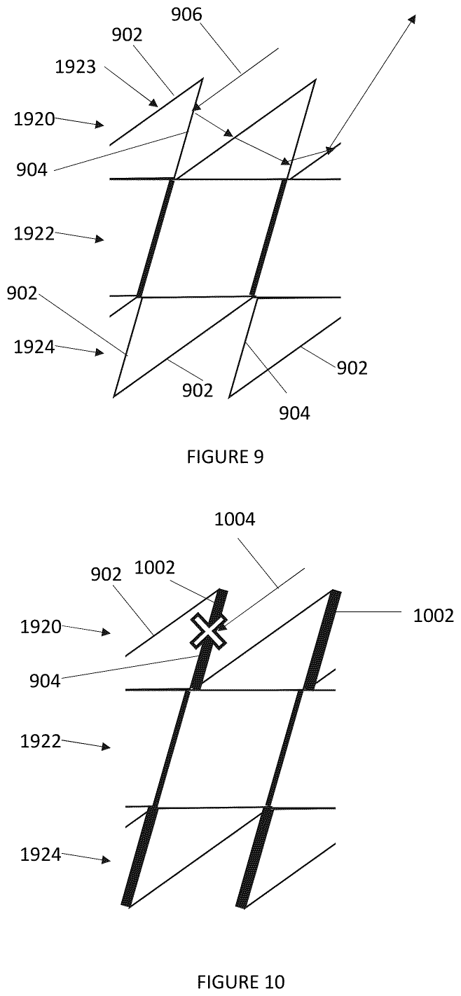

The reflection suppression device 1900 described above is generally very effective at suppressing most forms of glare. However, after thorough simulation and experimentation, the inventors have identified some additional sources of glare which may occur under certain conditions, in particular when ambient light is incident on the reflection suppression device 1900 at particular (narrow) ranges of angles. In an attempt to suppress the additional sources of glare, the inventors initially painted passive surfaces of the first and second serrated surfaces 1929, 1928. This is described in more detail below with respect to FIGS. 9 and 10.

FIG. 9 is a close-up cross-sectional view of a portion of the reflection suppression device 1900 of FIG. 6. Each of the first and second serrated surfaces 1929, 1928 of the reflection suppression device comprises an array of prism elements 1923, 1921 and each prism element defines an individual serration. Each individual serration comprises an active face 902 and a passive face 904. The active and passive face are labelled in FIG. 9. The active face 902 is the face through which the replica 1908 passes. The replica 1908 does not pass through the passive face 904. The passive face 904 is effectively an artefact of providing the first and second serration surface 1929, 1928 as an array of prism elements/angled surfaces. The inventors have identified that there is a risk that ambient light, incident on an external surface of the passive face 904, may be specularly reflected by the passive face 904. This may result in ambient light being received at the viewing window/eye-box.

In this example, ambient light 906 is incident on the passive face 904 of one of the prism elements 1923 of the first serrated surface 1929. The angle of incidence of the ambient light 906 on the passive face 904 is such that the ambient light is specularly reflected by the passive face 904. The ambient light 906 is then caused to propagate towards an adjacent prism element 1923. This time, the angle of incidence is such that the ambient light 906 propagates through the adjacent prism element 1923 before being reflected by another angled surface away from the reflection suppression device 1900 and on towards an eye-box/viewing window (not shown in FIG. 9). Thus, FIG. 9 shows an example of how ambient light 906, when incident on the passive face 904 at a very particular angle, can cause glare despite the various glare suppression mechanisms already employed by the reflection suppression device 900.

It should be clear that the example shown in FIG. 9 is just one example of an angle at which ambient light 906 incident on a passive face 904 of a prism element 1923 can cause glare to be received at an eye-box. The reflection suppression device 900 is a relatively complicated optical structure with a large number of different angled surfaces. Thus, there are various possible options for optical paths which similarly might cause a source of glare when ambient light is specularly reflected by the passive face 904.

As above, the inventors initially attempted to suppress such sources of glare by coating the passive faces 904 of the reflection suppression device 1900 with black paint. This is shown in FIG. 10 in which each passive face 904 is covered with a layer 1002 of black paint. After thorough simulation and experimentation, the inventors have found that the layers 1002 of black paint or indeed effective at suppressing said glare. This is represented in FIG. 10 by ambient light 1004 which is incident on passive face 904 comprising layer 1002. Onward propagation of the ambient light 1004 is prevented because the ambient light 1004 is absorbed by the black paint.

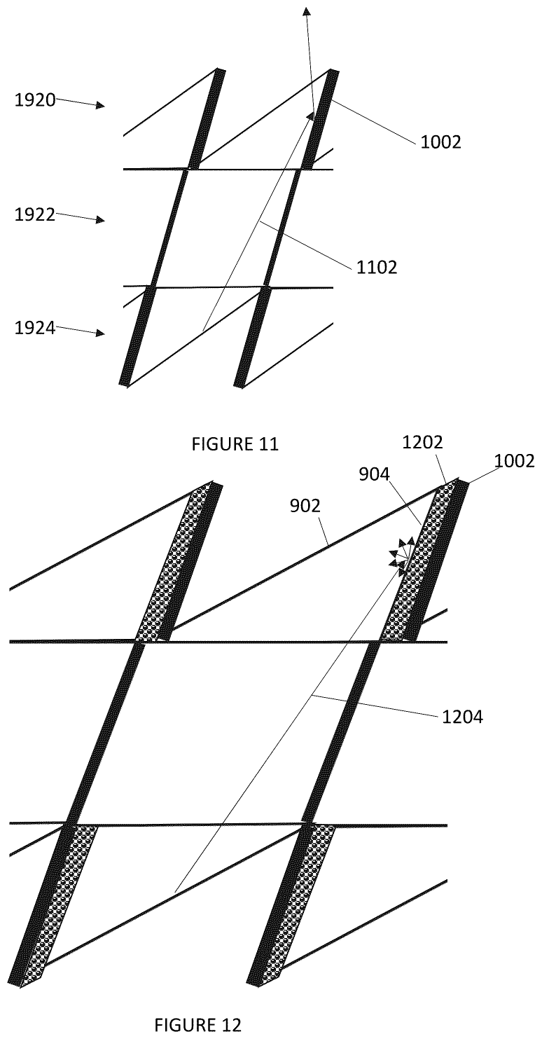

While the black paint layer may be effective at suppressing one form of glare, the inventors have surprisingly found that another form of glare is not suppressed by the black paint layer 1002. In particular, the inventors have found that the black paint layer may not suppress glare formed as an internal specular reflection of ambient light on the passive face 904. This is shown in FIG. 11. FIG. 11 shows ambient light 1102 propagating through the reflection suppression device 1900 comprising black paint layers 1002 on passive faces 904. Only a portion of the propagation path of the ambient light 1102 is shown in FIG. 11. In particular, the ambient light 1102 may have started its propagation from the first layer 1920, passing through the intermediate layer and the second layer 1924 before being reflected by the waveguide back to the reflection suppression device 1900. This portion of the propagation path is not shown in FIG. 11. The portion of the propagation path of the ambient light 1102 shown in FIG. 11 is represented by arrows.

The ambient light 1102 is incident on the internal side of a passive face 904 of the first layer 1920. The angle made by the ambient light 1102 and the passive face 904 is such that the ambient light is reflected by the passive face 904. There is an interface between the passive face 904 and the black paint layer 1002. There is also a differential refractive index at this interface. Therefore, there is a critical angle above which light incident on the passive face 904 is reflected, rather than transmitted, by the passive face 904. The angle made by the ambient light 1102 is at or above this critical angle. Thus, the ambient light 1102 is not transmitted through the passive face 904 and so cannot be absorbed and/or diffusely scattered by the black paint layer 1002. The ambient light 1102 is reflected before reaching the black paint layer 1002. The specularly reflected ambient light 1102 may be directed towards the eye-box/viewing window. Thus, the black paint layer 1002 is not effective at suppressing the glare mechanism represented in FIG. 11.

### Improved Glare Suppression Device

The inventors have devised an improved glare suppression device in which a first layer 1202 is formed on each passive face 904. In this example, the first layer has a plurality of structural features which are sized and shaped (or otherwise configured) to suppress specular reflection of ambient light incident thereon. In some examples, the first layer 1202 is a layer formed on the passive face 904, for example a pattern is formed on the passive face 904. In such examples, the first layer 1202 may be effectively formed of the same material that forms the prism elements of the respective first or second layer 1920, 1924. In such examples, there is no interface between the passive face 904 and the layer 1202. Thus, ambient light cannot be specularly reflected before it has interacted with the structural features (as was the case in FIG. 11). Alternatively, the first layer 1202 may be formed of a material having substantially the same refractive index as the prisms of the first or second layer 1920, 1924 such that there is interface with a significant differential in refractive index between the passive face 904 and the layer 1202. Again, this means that ambient light substantially cannot be specularly reflected before it has interacted with the structural features of the layer 1202.

In this example, the first layer 1202 is arranged to diffusely scatter light incident thereon. This is shown in FIG. 12 in which ambient light 1204 is incident on first layer 1202. The “fan” of arrows in FIG. 12 represents the fact that the ambient light 1204 is scattered over a wide range of angles (each angle having a corresponding low intensity).

In this example, the first layer 1202 has a surface roughness of 0.5 micrometres or greater, optionally 0.7 micrometres or greater. Said surface roughness is relatively much lower than a surface roughness of the active faces of the reflection suppression device, which have a surface roughness of 0.1 micrometres or lower.

In some examples, the relatively high surface roughness of the first layer 1202 is achieved by forming a pattern on the passive faces 904. In some examples, the first layer 1920 is formed in an injection moulding process. In such examples, the pattern may be formed as part of the moulding process. Alternatively, a hot embossing process may be used to form the pattern on the passive faces 904.

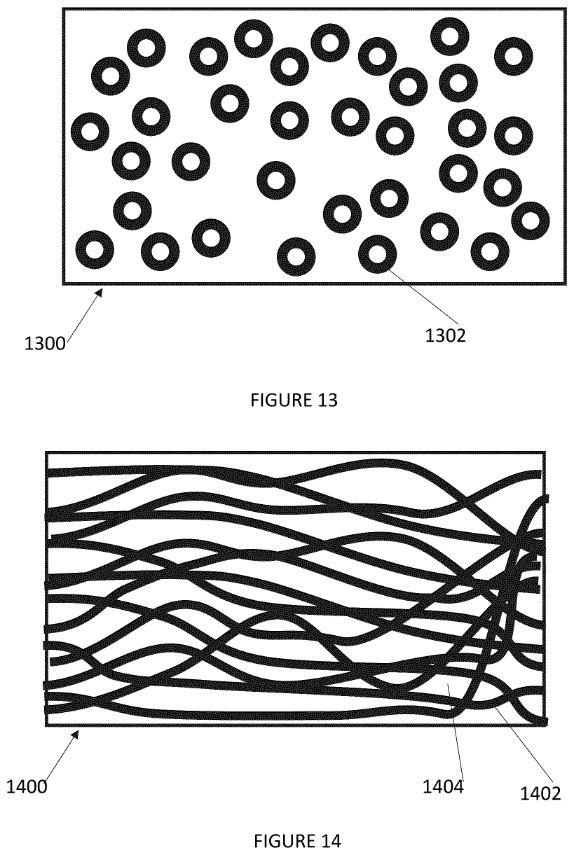

In some examples, the first layer 1202 is a porous polymer layer. The porous polymer comprises structural features configured to achieve said relatively high surface roughness of the first layer 1202. In some examples, the porous polymer comprises a plurality of pores. This is shown schematically in FIG. 13, which shows a porous polymer 1300 comprising a plurality of individual pores 1302. In these examples, it is the pores which are the structural features which are configured to suppress reflections (and achieve diffuse reflections/a relatively high surface roughness). In this example, the pores have a pore diameter of 200 micrometres. This achieves the suppression of specular reflection of ambient (visible) light.

In some examples, the first layer 1202 is a porous polymer layer and the porous polymer comprises a plurality of fibres or fibrils. This is shown schematically in FIG. 14, which shows a porous polymer 1400 comprising a plurality of individual fibres 1402. Interstices 1404 are defined between individual fibres 1402. In these examples, it is the fibres which are the structural features that are configured to suppress reflections (and achieve diffuse reflections/a relatively high surface roughness).

FIGS. 13 and 14 are both schematic close-up views. These figures are not to scale and show only a portion of the polymer.

Black paint layers 1002 (as described in relation to previous drawings) are provided on top of the first layer 1202.

Two example methods of forming a porous polymer layer as the first layer 1920 are described herein. Both of these methods comprise processing an already formed reflection suppression devices (for example, the reflection suppression device 1900 as shown in FIG. 6) or a component for a reflection suppression device (such as a component consisting of the first layer 1920 of the reflection suppression device 1900 only).

A first example method is a non-solvent induced phase separation process. This first method involves the use of a polymer processing solution comprising a dissolved polymer. Preferably, the dissolved polymer is the same polymer that is used to form the first layer 1920 (for example, polymethyl methacrylate). However, the dissolved polymer may be any polymer having a substantially similar refractive index as the polymer/material of the first layer. In this example, the polymer processing solution further comprises the solvent, acetone, and water (a non-solvent). The first method comprises applying the polymer processing solution to passive faces of the reflection suppression device/component. In examples, this achieved by dip-coating. Once a thin film coating of polymer processing solution has been applied to the passive faces, an evaporation process is performed. In particular, the solvent is evaporated from the polymer processing solution applied to the passive faces. This causes a phase separation between the polymer and the non-evaporated water. This forms a porous polymer layer having an isotropic fibril network.

A second example method is a polymerization-induced phase separation process. The second method involves the use of a polymer processing solution which comprises, in this example, monomers, porogens, and initiators, and is a solution which is triggered by ultraviolet radiation. The porogens and the monomers are miscible. The second method comprises dip-coating or spray coating the passive faces with the polymer processing solution. The method further comprises irradiating the passive faces with ultraviolet radiation to cure the polymer processing solution. This irradiation causes a phase separation of the porogens and the cured polymer. The radiation source can be arranged so as to irradiate (and cure) the polymer processing solution on the passive faces only. This it does not matter if the other (active) faces are also coated in polymer processing solution in this example of the method. The second method further comprises submerging the cured polymer in a solvent.

### Additional Features

The methods and processes described herein may be embodied on a computer-readable medium. The term “computer-readable medium” includes a medium arranged to store data temporarily or permanently such as random-access memory (RAM), read-only memory (ROM), buffer memory, flash memory, and cache memory. The term “computer-readable medium” shall also be taken to include any medium, or combination of multiple media, that is capable of storing instructions for execution by a machine such that the instructions, when executed by one or more processors, cause the machine to perform any one or more of the methodologies described herein, in whole or in part.

The term “computer-readable medium” also encompasses cloud-based storage systems. The term “computer-readable medium” includes, but is not limited to, one or more tangible and non-transitory data repositories (e.g., data volumes) in the example form of a solid-state memory chip, an optical disc, a magnetic disc, or any suitable combination thereof. In some example embodiments, the instructions for execution may be communicated by a carrier medium. Examples of such a carrier medium include a transient medium (e.g., a propagating signal that communicates instructions).

It will be apparent to those skilled in the art that various modifications and variations can be made without departing from the scope of the appended claims. The present disclosure covers all modifications and variations within the scope of the appended claims and their equivalents.

What is claimed is:

1. A component for a light control device, wherein the component comprises a first serrated structure having an array of active faces and a respective array of passive faces, wherein individual passive faces comprise a respective first layer having at least one structural feature configured to suppress a specular reflection of ambient light incident thereon.

2. The component of claim 1, wherein the first serrated structure is formed of a transparent core material having a first refractive index, and wherein each respective first layer of each passive face comprises a material having a refractive index that is substantially equal to the first refractive index.

3. The component of claim 1, wherein the first serrated structure comprises a plurality of serrations, wherein each serration comprises an active face of the array of active faces and a respective passive face of the array of passive faces such that the active faces and passive faces are arranged in an alternating configuration.

4. The component of claim 1, wherein at least one of (i) the respective first layer of each passive face comprises a polymer or (ii) the at least one structural feature is contained within a polymer.

5. The component of claim 1, wherein the at least one structural feature has a size of between 50 and 800 nanometres.

6. The component of claim 1, wherein the respective first layer of one or more passive faces comprises at least one structural feature, and wherein the at least one structural feature comprises one or more pores.

7. The component of claim 1, wherein the respective first layer of one or more passive faces comprises at least one structural feature, and wherein the at least one structural feature comprises one or more fibres or fibrils.

8. The component of claim 1, wherein the component comprises a bulk polymer forming the first serrated structure.

9. The component of claim 8, wherein the bulk polymer comprises a substantially transparent material.

10. The component of claim 9, wherein a refractive index of the bulk polymer is substantially the same as a refractive index of the respective first layer of each passive face.

11. The component of claim 8, wherein the bulk polymer comprises a first polymer and the respective first layer of each passive face is a polymer layer also comprises the first polymer.

12. The component of claim 11, wherein the first polymer is polymethyl methacrylate.

13. The component of claim 1, wherein the respective first layer of each passive face is a thin film polymer layer.

14. The component of claim 1, wherein individual passive faces further comprise a second layer configured to substantially absorb light incident thereon.

15. The component of claim 14, wherein the second layer comprises paint.

16. The component of claim 14, wherein the second layer at least partially permeates the first layer.

17. The component of claim 1, wherein a root mean square surface roughness of each active surface is 0.1 micrometers or less.

18. The component of claim 1, wherein a root mean square surface roughness of each passive surface is 0.5 micrometers or greater.

19. A light control device comprising:
a component comprising a first serrated structure having an array of active faces and a respective array of passive faces, wherein individual passive faces comprise a first layer having at least one structural feature configured to suppress a specular reflection of ambient light incident thereon; and
a plurality of louvres in an array, wherein individual louvres comprise a light absorbing material.

20. A head-up display, wherein the head-up display comprises:
an optical component having a reflective surface arranged, during head-up display operation, in a configuration that is conducive to sunlight glare;
a light control device comprising (i) a component comprising a first serrated structure having an array of active faces and a respective array of passive faces, wherein individual passive faces comprise a first layer having at least one structural feature configured to suppress a specular reflection of ambient light incident thereon, and (ii) a plurality of louvres in an array, wherein individual louvres comprise a light absorbing material; and
wherein the light control device is arranged to receive ambient light on an optical path to the reflective surface of the optical component.

21. The head-up display of claim 20, wherein the optical component is a waveguide.

22. A method of processing a component for a light control device, wherein the component comprises a first serrated structure having an array of active faces and a respective array of passive faces, and where the method comprises:
forming a first layer on each passive face, wherein the first layer comprises at least one structural feature configured to suppress reflection of ambient light incident thereon.

23. The method of claim 22, wherein forming the first layer on each passive face comprises applying a polymer processing solution to the component by one of spraying or dip-coating the component.

24. The method of claim 23, wherein the polymer processing solution applied to the component comprises a solvent, a non-solvent, and a dissolved polymer, and wherein the method further comprises:
evaporating the solvent from the polymer processing solution applied to the component.

25. The method of claim 23, wherein the polymer processing solution applied to the component comprises a plurality of monomers and a plurality of porogens, and wherein the method further comprises:
irradiating the applied polymer processing solution to form a cured porous polymer.
